(19) United States
(12) Patent Application Publication
(10) Pub. No.: US 2004/0068431 A1
(43) Pub. Date: Apr. 8, 2004

(54) Methods and systems for evaluation of business performance

(75) Inventors: Michael W. Smith, Oak Ridge, NC (US); Audrey Apfel, Stamford, CT (US); Ken Bergstrom, Bethel, CT (US)

Correspondence Address: LAW OFFICE OF BARRY R LIPSITZ, 755 MAIN STREET, MONROE, CT, 06468, US

(73) Assignee: Gartner, Inc., Stamford, CT (US)

(21) Appl. No.: 10/678,476

(22) Filed: Oct. 3, 2003

Related U.S. Application Data
(60) Provisional application No. 60/417,022, filed on Oct. 7, 2002.

(51) Int. Cl. G06F 17/60

(52) U.S. Cl. 705/10

(57) ABSTRACT

Methods and systems for evaluation of business performance are provided. All actionable activities of a business are divided into a plurality of business aspects. A plurality of aggregate measures is then established for each business aspect. Each of the aggregate measures comprises a set of related actionable activities for a respective business aspect. A plurality of prime measures is established for each aggregate measure. Each of the prime measures quantifies one or more actionable activities from the set of related actionable activities. A value of at least one of the prime measures may be calculated to provide an indication of business performance. In addition, the value of each aggregate measure may be calculated by multiplying the values of each of the prime measures for that aggregate measure together to provide an indication of business performance. Multiplying the values of the aggregate measures together provides an indication of overall business performance.

This application claims the benefit of U.S. provisional patent application No. 60/417,022 filed on Oct. 7, 2002, which is incorporated herein and made a part hereof by reference.

### BACKGROUND OF THE INVENTION

The present invention relates to the measurement of business performance. More specifically, the present invention relates to methods and systems for evaluating business performance that are applicable to any business. The methods and systems of the present invention employ both financial and non-financial measures in evaluating the performance of a business, thereby providing a more accurate evaluation of business performance.

Two concepts that are fundamental to a discussion of performance measures are standard and non-financial. The term “standard” as used herein shall mean “performance measures that are well defined and commonly and consistently used”. Standard measures are not necessarily set by legal authority. For example, in the United States, the Financial Accounting Standards Board (FASB) is not a legal authority, but rather an “independent, private sector organization following an open, due process”. The term “non-financial” as used herein is simply defined as “those performance measures that are not financial”. Financial measures are those measures that are set by recognized accounting authorities for external reporting purposes. Therefore, non-financial measures are essentially all other business performance measures.

Standard financial measures have not kept pace with the factors that drive business value. Since 1980 research has shown that knowledge management and the management of intangible assets have become increasingly significant in determining real business value. However, a lack of generally accepted standards to measure these capabilities has eroded the relevancy of information available to investors and business executives in deciding where to find and how to build business value. This erosion has occurred gradually over the past twenty years as business models and organizational boundaries have become more sophisticated. The shrinking relevancy of comparable, auditable performance measures increases uncertainty and risk by creating an environment for subjective decision-making. Investments in information technology enabled business initiatives were excessive during the late '90's. That trend has been replaced by over-caution where many financially sound initiatives are being postponed or rejected. However, despite all the knowledge and information available have objective, comparable and audible measures of real business value have not been defined, and commonly and consistently used.

In 1982, the average market capitalization of a company in the S&P 500 was 1.3 times book value. Book value is calculated by using standard accounting measures. In 1998 market capitalization was 5 to 6 times book value, leaving over 80% of market value unexplained by standard accounting measures. How was this additional value determined? What were the executives of these companies focusing on to generate this value? By November of 2001, market capitalization had fallen back to just under 3 times book value, still leaving over 60% unexplained by standard accounting measures. This decline in market capitalization has brought with it much pain. Hundreds of thousands of jobs have been lost, businesses have disappeared, and consumer confidence has been shaken. Financial analysts explain that the market price of a company's stock is based primarily on future earnings. So the cause of this decline in market value must be due to a decline in expected earnings. But even with all the knowledge and information available, dramatic swings in expected earnings are still experienced.

Prior art methodologies such as the Balanced Scorecard, the Supply Chain Council, Total Quality Management (TQM), European Foundation for Quality Management (EFQM), Six Sigma and many other methodologies have helped executives extend their focus beyond traditional accounting measures. In particular, the Balanced Scorecard has provided management with a useful means of translating vision to action and to receive feedback on this vision through selected operational performance measures. TQM, EFQM and Six Sigma have provided a means for identifying non-accounting operational measures that can serve as leading indicators of financial results. A recent and interesting prior art development is the establishment of reference models. Reference models contain predefined measures for specific business processes. The Supply Chain Council and more recently the Product Development and Management Association have initiatives in this area. These efforts together with the efforts of companies providing benchmarking services and best practices services have advanced the state-of-the-art in business performance measurement. Without this work it would be difficult to see how businesses could extend the use of standard performance measurement beyond traditional accounting to include forward looking measures that drive positive change. However, it is possible for standard, non-financial business performance frameworks to form a broader foundation upon which management can base its decisions. In doing so, executive management will increase the transparency between internally created and externally perceived business value.

In the United States, the Financial Accounting Standards Board (FASB) uses a set of values to define Generally Accepted Accounting Principles (GAAP). These values are based on concepts like conservatism and materiality. However, as discussed above, an issue has developed where the rate of change in the forces driving business value has exceeded the rate of progress FASB has made in defining standards to measure them. For example, much of the focus of GAAP has been on fixed assets. Many companies, however, no longer buy all their fixed assets, they lease at least a portion of them. If Book Value=(Assets−Liabilities) and Company A leases while company B buys it assets, then Company A's Book Value is understated. Knowledge management and the management of intangible assets are also inadequately measured by accounting standards. This has created a measurement-gap. As mentioned previously, 80% of market value in the S&P 500 was unexplained by GAAP in 1998. The measurement gap creates uncertainty by requiring business executives to use ad-hoc, subjective and unauditable measures to guide them on ways of creating real business value. Risk is a function of uncertainty, and risk affects perceived shareholder value. All things being equal, the greater the uncertainty, the lower the market value of a company.

There is no shortage of prior art business performance measures available. The automation of business transactions in software applications like Enterprise Resource Planning (ERP) and Customer Relationship Management (CRM) has resulted in the proliferation of performance measures at all levels of management. In fact, automated transaction systems provide hundreds of predefined key performance indicators. This creates an issue. Research has discovered that a typical manager at any level in the organization can effectively deal with 7 (plus or minus 2) key performance indicators on a continuous basis. Facing information overload, management must select the “valued-few” performance measures it can cope with. The challenge here is two-fold. First, selecting the right measures that are leading indicators of financial performance. Second, knowing whether the results of those measures, in the absence of industry relative benchmarks, are good or bad.

Standardization of non-financial performance measures is encouraged by the need for collaboration between existing and potential trading partners. As enterprises continue to focus on core competencies and outsource other business processes, integration of business processes between suppliers and customers is becoming more critical. For product companies, the Supply Chain Council has defined a set of collaborative performance measures that can be used to ensure efficiencies are maintained as business functions move outside the enterprise. With service suppliers, service level agreements are becoming the focal point for determining the value provided and received. The Product Development and Management Association has announced plans for defining a reference model of standard performance measures for collaborative product development. Non-financial performance measures are required that are generally accepted between companies so that comparisons and decisions can be made quickly, maintaining performance throughout the value net.

Standardization of non-financial business measures will provide many useful benefits to investors and business executives. Accounting standards give rules to the business of auditing the financial results of a company increasing the credibility of financial reporting. Accounting standards are essential for capital markets to function. The process by which these standards are established and audited is coming under much scrutiny at the present time because of the events surrounding the Enron accounting scandal. This scrutiny highlights how important standard business measures are to investors and executives alike in making decisions regarding real business value. When we look beyond existing accounting measures to the operational measures organizations use to guide and grow business value, the benefits of standardization are equally compelling. Standard measures provide a common language and a set of definitions for discussing operational performance, comparing performance between companies and between entities within the same company. However, operational performance standards do not exist. What investors and business executives need is standards of operational performance for the guidance and education of business management in order to fill the measurement-gap.

It is instinctive for managers at all levels to fall back on fundamental principles during periods of uncertainty. The well-known axiom, “you can not manage what you can not measure, you can not measure what you can not define” seems to take on more significance during periods of uncertainty. Defining and measuring are necessary conditions for management to occur. However, the issue is not with defining and measuring business activity. Recent advances in information technology have provided business management with data and metrics that are overwhelming. The real issue is how to use these data and metrics to make better decisions. Supported by new reference models, methodologies and advancement in information technology, performance measurement can provide greater insight into the cause-and-effect relationships between operating events and financial results. Executives can then use these cause-and-effect relationships as extensions to traditional accounting measures to build and grow real business value.

There are three related efforts that are advancing the role of non-financial measures in contemporary management systems. These can be categorized as methodologies, certifications, and reference models. As mentioned previously, Drs. Kaplan and Norton developed the Balanced Scorecard methodology to help executives look beyond financial measures in linking vision to action. The Harvard Business Review has acclaimed the Balanced Scorecard as one of the most influential ideas of the past 75 years. The acceptance of the Balanced Scorecard is recognition of management's need for tools that clearly and objectively define and measure business activity not captured by financial metrics alone. The Total Quality Management (TQM) and Six Sigma methodologies have developed non-financial measures that are effective leading indicators of financial results. Certification efforts are being spearheaded by organizations like ISO and public accounting firms that focus on the internal processes from which measures are generated. The Supply Chain Council, and most recently the Product Development and Management Association, are working on reference models containing specific measures for defined business processes. Both of these organizations draw on the work of the methodology and certification groups together with industry consortia to establish and maintain these reference models.

Supply Chain Management processes contain many specific measures like on-time delivery and order fill rate with defined calculations that can be audited and compared. Additional reference models will be built in key areas like demand management, and shared services. When integrated properly, these and future reference models will form the building blocks for standard business performance frameworks.

The recent work done by the methodology, certification and reference model groups discussed above has provided the necessary but not sufficient capability to close the measurement gap. Without the work accomplished by these groups, closing the measurement gap would be difficult. Agreement on standard, non-financial measures would take years. But, through the work of the measurement methodologies (Balanced Scorecard, TQM, EFQM, Six Sigma), reference models are providing measures that, taken together, are effective leading indicators of financial performance and are well recognized and generally accepted. What is missing is a set of principles, similar to Generally Accepted Accounting Principles (GAAP), that organize and integrate existing and future reference models into a holistic view of the enterprise. These principles must provide flexibility and growth as business practices evolve and change. In this way, the principles create a business measurement framework that can be used by executives and managers to help guide and grow the value of their organizations.

The present invention provides a business measurement framework consisting of a set of precisely defined performance metrics that extend standard financial reporting measures and include non-financial performance measures, representing a complete and holistic view of an enterprise's business operations will close the gaps in determining real business value.

The methods and systems of the present invention provide the foregoing and other advantages.

### SUMMARY OF THE INVENTION

The present invention relates to methods and systems for the evaluation of business performance.

In an example embodiment of the invention, a method for evaluation of business performance is provided. All actionable activities of a business are divided into a plurality of business aspects. A plurality of aggregate measures is then established for each business aspect. Each of the aggregate measures comprises a set of related actionable activities for a respective business aspect. A plurality of prime measures (also referred to herein as “prime metrics”) is established for each aggregate measure. Each of the prime measures quantifies one or more actionable activities from the set of related actionable activities. A value of at least one of the prime measures may be calculated to provide an indication of business performance.

Values of each of the prime measures for at least one of the aggregate measures may be calculated. The value of at least one of the aggregate measures may then be calculated by multiplying the values of each of the prime measures for that aggregate measure together to provide an indication of business performance.

Values of each of the prime measures for each of the aggregate measures may be calculated. A value of each aggregate measure may then be calculated by multiplying the values of each of the prime measures for that aggregate measure together to provide an indication of overall business performance.

Each prime measure may provide a basis to determine an impact of a business project or process on overall business performance.

The aggregate measures and the prime measures collectively comprise leading indicators of financial performance.

The plurality of prime measures is collectively exhaustive of the actionable activities of the business. Further, each prime measures is exclusive of all other prime measures.

A subset of the plurality of prime measures for each respective aggregate measure may be selected which best defines that aggregate measure for the business. The value of at least one of the prime measures from at least one of the selected subsets may be calculated to provide an indication of the business performance.

The selected subset of prime measures for each aggregate measure may consist of between five and nine prime measures. For example, the selected subset of prime measures for each aggregate measure may comprise seven prime measures.

In an example embodiment of the invention, at least one industry standard prime measure may be added to at least one of the selected subsets of prime measures. Further, at least one of the prime measures in at least one of the selected subsets may be customized to better define at least one of the aggregate measure for the business.

In a further example embodiment of the invention, the plurality of business aspects may comprise at least a demand management aspect, a supply management aspect, and a support services aspect.

The plurality of aggregate measures established for the demand manage aspect may comprise at least a market responsiveness aggregate measure, a sales effectiveness aggregate measure, and a product development effectiveness aggregate measure. The plurality of aggregate measures established for the supply management aspect may comprise at least a customer responsiveness aggregate measure, a supplier effectiveness aggregate measure, and an operational efficiency aggregate measure. The plurality of aggregate measures established for the support services aspect may comprise at least a human resources responsiveness aggregate measure, an information technology responsiveness aggregate measure, and a finance and regulatory responsiveness aggregate measure.

The plurality of prime measures established for the market responsiveness aggregate measure may comprise at least the following prime measures: target market index, market coverage index, market share index, opportunity/threat index, product portfolio index, channel profitability index, and configurability index.

The plurality of prime measures established for the sales effectiveness aggregate measure may comprise at least the following prime measures: sales opportunity index, sales cycle index, sales close index, sales price index, cost of sales index, forecast accuracy, and customer retention index.

The plurality of prime measures established for the product development effectiveness aggregate measure may comprise at least the following prime measures: new products index, feature function index, time to market index, and research and development success index.

The plurality of prime measures established for the customer responsiveness aggregate measure may comprise at least the following prime measures: on-time delivery, order fill rate, material quality, service accuracy, service performance, customer care performance, agreement effectiveness, and transformation ratio.

The plurality of prime measures established for the supplier effectiveness aggregate measure may comprise at least the following prime measures: supplier on-time delivery, supplier order fill rate, supplier material quality, supplier service accuracy, supplier service performance, supplier care performance, supplier agreement effectiveness, and supplier transformation ratio.

The plurality of prime measures established for the operational efficiency aggregate measure may comprise at least the following prime measures: cash-to-cash cycle time, conversion cost, asset utilization, and sigma value.

The plurality of prime measures established for the human resources responsiveness aggregate measure may comprise at least the following prime measures: recruitment effectiveness index, benefits administration index, skills inventory index, employee training index, human resources advisory index, and human resources total cost index.

The plurality of prime measures established for the information technology responsiveness aggregate measure may comprise at least the following prime measures: systems performance, IT support performance, partnership ratio, service level effectiveness, new projects index, and IT total cost index.

The plurality of prime measures established for the finance and regulatory responsiveness aggregate measure may comprise at least the following prime measures: compliance index, accuracy index, advisory index, and cost of service index.

A change in one prime measure may cause a change in one or more other prime measures, which in turn may cause changes in other prime measures. For example, a change in the target market index may cause a change in at least one of the market share index, the opportunity/threat index, the market coverage index, the sales cycle index, the sales close index, and the new products index.

A change in the market coverage index may cause a change in at least one of the market share index, the product portfolio index, the sales opportunity index, the sales cycle index, the sales close index, the sales price index, the cost of sales index, the forecast accuracy index, the on-time delivery, and the service accuracy.

A change in the market share index may cause a change in at least one of the opportunity/threat index, the sales cycle index, the sales close index, the forecast accuracy index, and the new products index.

A change in the opportunity/threat index may cause a change in at least one of the target market index, the market share index, the product portfolio index, the sales cycle index, the sales close index, the forecast accuracy index, and the new products index.

A change in the product portfolio index may cause a change in at least one of the market share index, the opportunity/threat index, the sales cycle index, the sales close index, the forecast accuracy index, and the new products index.

A change in the channel profitability index may cause a change in at least one of the market share index, the opportunity/threat index, the configurability index, the market coverage index, the sales cycle index, the sales close index, and the cost of sales index.

A change in the configurability index may cause a change in at least one of the market share index, the opportunity/threat index, the sales cycle index, the sales close index, the cost of sales index, the on-time delivery, the order fill rate, the material quality, the service accuracy, and the sigma value.

A change in the sales opportunity index may cause a change in at least one of the market share index, the product portfolio index, the sales cycle index, the sales close index, the sales price index, and the forecast accuracy index.

A change in the sales cycle index may cause a change in at least one of the market share index, the product portfolio index, the sales close index, and the forecast accuracy index.

A change in the sales close index may cause a change in at least one of the market share index, the product portfolio index, the sales cycle index, and the forecast accuracy index.

A change in the sales price index may cause a change in at least one of the sales cycle index, the sales close index, and the cost of sales index.

A change in the cost of sales index may cause a change in at least one of the sales cycle index, the sales close index, and the sales price index.

A change in the forecast accuracy may cause a change in at least one of the on-time delivery, the order fill rate, the cash-to-cash cycle time, the conversion cost, and the asset utilization.

A change in the customer retention index may cause a change in at least one of the market share index, the sales cycle index, the sales close index, the sales price index, and the cost of sales index.

A change in the new products index may cause a change in at least one of the target market index, the market share index, the opportunity/threat index, the configurability index, the product portfolio index, the sales cycle index, and the sales close index.

A change in the feature function index may cause a change in at least one of the target market index, the market share index, the opportunity/threat index, the configurability index, the product portfolio index, the sales cycle index, the sales close index, the conversion cost index, and the asset utilization.

A change in the time to market index may cause a change in at least one of the market share index, the configurability index, the product portfolio index, the sales cycle index, and the sales close index.

A change in the research and development success index may cause a change in at least one of the market share index, the opportunity/threat index, the configurability index, the product portfolio index, the sales cycle index, and the sales close index.

A change in the on-time delivery may cause a change in at least one of the market share index, the configurability index, the sales cycle index, the sales close index, the cash-to-cash cycle time, the conversion cost, and the asset utilization.

A change in the order fill rate may cause a change in at least one of the market share index, the configurability index, the sales cycle index, the sales close index, the cash-to-cash cycle time, the conversion cost, and the asset utilization.

A change in the material quality may cause a change in at least one of the market share index, the configurability index, the sales cycle index, the sales close index, the cash-to-cash cycle time, the conversion cost, and the asset utilization.

A change in the service accuracy may cause a change in at least one of the market share index, the configurability index, the sales cycle index, the sales close index, the cash-to-cash cycle time, the conversion cost, and the asset utilization.

A change in the service performance may cause a change in at least one of the agreement effectiveness, and the transformation ratio.

A change in the customer care performance may cause a change in at least one of the agreement effectiveness, the transformation ratio, and the service performance.

A change in the agreement effectiveness may cause a change in at least one of the market share index, the sales cycle index, the sales close index, the cash-to-cash cycle time, the conversion cost, and the asset utilization.

A change in the transformation ratio may cause a change in at least one of the market share index, the sales cycle index, the sales close index, the cash-to-cash cycle time, the conversion cost, and the asset utilization.

A change in the supplier on-time delivery may cause a change in at least one of the time to market index, the on-time delivery, the order fill rate, the cash-to-cash cycle time, the conversion cost, and the asset utilization.

A change in the supplier order fill rate may cause a change in at least one of the market share index, the sales cycle index, the sales close index, the cash-to-cash cycle time, the conversion cost, and the asset utilization.

A change in the supplier material quality may cause a change in at least one of the market share index, the sales cycle index, the sales close index, the cash-to-cash cycle time, the conversion cost, and the asset utilization.

A change in the supplier service accuracy may cause a change in at least one of the market share index, the sales cycle index, the sales close index, the cash-to-cash cycle time, the conversion cost, and the asset utilization.

A change in the supplier service performance may cause a change in at least one of the supplier care performance, the supplier agreement effectiveness, and the supplier transformation ratio.

A change in the supplier care performance may cause a change in at least one of the supplier agreement effectiveness, the supplier transformation ratio, and the supplier service performance.

A change in the supplier agreement effectiveness may cause a change in at least one of the market share index, the sales cycle index, the sales close index, the cash-to-cash cycle time, the conversion cost, and the asset utilization.

A change in the supplier transformation ratio may cause a change in at least one of the market share index, the sales cycle index, the sales close index, the cash-to-cash cycle time, the conversion cost, and the asset utilization.

A change in the cash-to-cash cycle time may cause a change in at least one of the supplier on-time delivery, the supplier order fill rate, the supplier material quality, the supplier service accuracy, the conversion cost, and the asset utilization.

A change in the conversion cost may cause a change in at least one of the supplier on-time delivery, the supplier order fill rate, the supplier material quality, the supplier service accuracy, and the asset utilization.

A change in the asset utilization may cause a change in at least one of the on-time delivery, the order fill rate, the material quality, the service accuracy, the cash-to-cash cycle time, and the conversion cost.

A change in the sigma value may cause a change in at least one of the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the recruitment effectiveness index may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the benefits administration index may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the skills inventory index may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the employee training index may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, the asset utilization, and the recruitment effectiveness index.

A change in the human resources advisory index may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the human resources total cost index may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the systems performance may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the IT support performance may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the partnership ratio may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the service level effectiveness may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the new projects index may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the IT total cost index may cause a change in at least one of the sales cycle index, the sales close index, the forecast accuracy index, the time to market index, the research and development success index, the on-time delivery, the order fill rate, the material quality, the service accuracy, the supplier on-time delivery, the supplier order fill rate, the supplier material quality, the supplier service accuracy, the cash-to-cash cycle time, the conversion cost, and the asset utilization.

A change in the compliance index may cause a change in at least one of the time to market index, the cash-to-cash cycle time, the conversion cost, and the asset utilization.

A change in the accuracy index may cause a change in at least one of the cash-to-cash cycle time, the conversion cost, and the asset utilization.

A change in the advisory index may cause a change in at least one of the time to market index, the conversion cost, and the asset utilization.

A change in the cost of service index may cause a change in at least one of the conversion cost and the asset utilization.

Certain of the prime measures are unique to the present invention, while others are widely used and well known in the field of business performance. The prime measures which are unique to the present invention are target market index, market coverage index, market share index, opportunity/threat index, product portfolio index, configurability index, feature function index, service performance, customer care performance, agreement effectiveness, transformation ratio, supplier service performance, supplier care performance, supplier agreement effectiveness, supplier transformation ratio, recruitment effectiveness index, skills inventory index, employee training index, human resources advisory index, system performance, IT support performance, partnership ratio, service level effectiveness, new projects index, compliance index, accuracy index, and advisory index.

The target market index may be calculated by selecting appropriate target market industries based on current product and/or service offerings and planned and budgeted offerings of the business over a future twelve month period using International Standard Industrial Classification codes. A relative market size may be obtained by summing revenue of selected target market industries and dividing the sum by normalized industry revenue. The relative market size can then be multiplied by relative market growth rate plus one to provide the target market index, wherein the relative market growth rate plus one is a weighted average growth rate of all target market industries.

The market coverage index may be calculated by selecting appropriate target market industries based on current product and/or service offerings of the business using International Standard Industrial Classification codes. Then, the market coverage index may be provided by dividing a number of countries in which the business has sold its products or services by a total number of countries where revenue exists for the target market industries selected.

The market share index may be calculated by selecting appropriate target market industries based on current product and/or service offerings of the business using International Standard Industrial Classification codes. Then, the market share index may be provided by dividing revenue of the products and/or services offered by the business by total revenue of the selected target market industries.

The opportunity/threat index may be calculated by selecting appropriate target market industries based on current product and/or service offerings and planned and budgeted offerings of the business over a future twelve month period using International Standard Industrial Classification codes. The market share index may then be computed for each top five competitor of the business in the selected target market industries by dividing total revenue of each competitor by total revenue of target market industries for each competitor. Adding the market share indexes for the top five competitors provides the opportunity/threat index.

The product portfolio index may be calculated by creating a grid starting with a point 0,0 in a lower left corner with gross margin figures labeled on a horizontal axis and growth rate figures labeled on a vertical axis. The current product or service of the business with the highest growth rate in annual revenue is determined. The growth rate of the product or service with the highest growth rate is divided by two to provide a midpoint of the vertical axis of the grid. A current product or service with the highest gross margin in absolute dollar terms is determined. The dollar gross margin figure of the product or service with the highest gross margin is divided by two to provide a midpoint of the horizontal axis. The respective midpoints of the horizontal and vertical axis are extended to define four quadrants of the grid. All products and/or services currently offered by the business are plotted on the grid based on respective growth rates and gross margins in dollar terms. The product portfolio index is provided by dividing the total revenue of the products and services in all quadrants except the lower left quadrant by the total revenue of the business.

The configurability index may be calculated by determining total revenue generated from options offered on products and services offered by the business during a previous twelve month period and dividing the total revenue generated from the options by total revenue of the business. An option is defined as a feature or function that is purchased as part of a basic product or service and that is not required for the basic product or service to function.

For businesses selling a product, the feature function index may be calculated dividing a number of new component items listed on a bill-of-materials for products released to market during a previous 12 month period by a total number of component items on the bill-of-materials. For businesses selling a service, the feature function index may be calculated by dividing a number of new skill sets required on a bill-of-services for new service offerings released to market during a previous 12 month period by a total number of skill sets required on the bill-of-services.

For a continuous request service, the service performance may be calculated by dividing a percentage of hours the service is available to a customer of the business and performing adequately by total hours the service is expected to be available for the customer. For a discrete request service, the service performance may be calculated by dividing a number of customer requests that are adequately responded to and completed by a total number of requests made by the customer during standard hours of operation.

Customer care performance may be calculated by dividing a number of customer care requests which meet predefined response and resolution criteria by the total number of customer care requests received during standard hours of operation of the business.

Agreement effectiveness may be calculated by dividing a total number of existing customers with a 90% or better service level agreement satisfaction by the total number of existing customers. The satisfaction may be based on survey questions relating to the service level agreement.

The transformation ratio may be calculated by dividing (i) a total number of existing customer contracts and engagements and planned contracts and engagements for a future 12 month period, for which goals and benefits are projected in terms of business metrics and for which a roles and responsibilities matrix exists that holds both the business and customer responsible for achieving the projected benefits, by (ii) a total number of existing customer contracts and engagements.

For a continuous request service of a supplier, supplier service performance may be calculated by dividing a percentage of hours the service is available to the business and performing adequately by total hours the service is expected to be available for the business. For a discrete request service of a supplier, supplier service performance may be calculated by dividing a number of requests from the business that are adequately responded to and completed by a total number of requests made by the business during standard hours of operation.

Supplier care performance may be calculated by dividing a number of supplier care requests meeting predetermined response and resolution criteria by the total number of supplier care requests made by the business during standard hours of operation.

Supplier agreement effectiveness may be calculated by dividing a total number of existing service providers with a 90% or better service level agreement satisfaction by the total number of existing service providers. The satisfaction may be based on survey questions relating to the service level agreement.

The supplier transformation ratio may be calculated by dividing (i) a total number of existing supplier contracts and engagements and planned contracts and engagements for a future 12 month period, for which goals and benefits are projected in terms of business metrics and for which a roles and responsibilities matrix exists that holds both the business and the supplier responsible for achieving the projected benefits, by (ii) a total number of existing supplier contracts and engagements.

The recruitment effectiveness index may be calculated by multiplying average relative recruitment time by relative recruitment cost for each employee hired during a previous 12 month period. The relative recruitment time may be calculated by subtracting from 1 a quotient provided by a length of time, measured in days, between recruitment approval and hire date divided by 365. The relative recruitment cost is calculated by subtracting from 1 a quotient provided by total recruitment costs divided by committed first year compensation for the hired employees.

The skills inventory index may be calculated by dividing a total number of skills filled by existing employees by a total number of skills required by a business to complete all of the actionable activities.

The employee training index may be calculated by dividing (i) a total number of 8-hour working days each employee has spent in training sponsored by the business during a previous 12 month period by (ii) a product of 225 multiplied by a number of full time equivalent employee positions.

The human resources advisory index may be calculated by dividing (i) a total number of existing human resources projects and projects planned for a future 12 month period, for which goals and benefits are projected in terms of business metrics and for which a roles and responsibilities matrix exists that holds both a human resources department and other business functions responsible for achieving the projected benefits, by (ii) a total number of planned strategic initiatives at a corporate level.

System performance may be calculated by dividing an amount of hours all systems are available to the business and performing adequately by total hours the systems are expected to be available.

IT support performance may be calculated by dividing a number of IT support requests meeting predetermined response and resolution criteria by a total number of IT support requests received during standard hours of operation.

The partnership ratio may be calculated by dividing (i) a total number of existing IT projects and projects planned for a future 12 month period, for which goals and benefits are projected in terms of business metrics and for which a roles and responsibilities matrix exists that holds both an IT department and other business functions responsible for achieving the projected benefits, by (ii) a total number of IT projects.

Service level effectiveness may be calculated by dividing a total number of surveyed users with 90% or better service level effectiveness by a total number of surveyed users.

The new projects index may be calculated by dividing (i) a total number of projects that were (a) undertaken within a previous 12 month period and (b) that are currently underway, that operated or are operating on or below budget, at or ahead of schedule, and delivering at least a business value expected from an initial business case, by (ii) a total number of projects, including projects that were undertaken within the previous twelve month period and projects that are currently underway.

The compliance index may be calculated by calendaring by month a total number of legal and regulatory filings and transactions required to conduct normal business operations. Then, subtracting from 1 a quotient provided by a number of extensions, late, missed or incorrect filings and transactions for a previous 12 month period divided by the total for the 12 month period.

The accuracy index may be calculated by calendaring by month a total number of documents and reports requested from all internal business operations. Then, subtracting from 1 a quotient provided by a number of declined requests, missed deadlines or adjustments necessary following delivery of the document or report divided by the total number requested.

The advisory index may be calculated by dividing (i) a total number of existing finance and/or regulatory projects and projects planned for a future 12 month period, for which goals and benefits are projected in terms of business metrics and for which a roles and responsibilities matrix exists that holds both a finance and regulatory department and other business functions responsible for achieving the projected benefits, by (ii) a total number of planned strategic initiatives at a corporate level.

Certain of the known prime measures are not expressed as an index (i.e., in percentage form which denotes an improvement as the percentage increases). Therefore, in order to be meaningful in the context of the present invention, these prime measures must be expressed as an index. A non-index based prime measure may be converted into an index-based prime measure by subtracting from 1 a quotient provided by a value of the non-index based prime measure divided by an upper bound of the non-index based prime measure.

The non-index based prime measure may comprise the sales cycle index, which is expressed by a number of days. The upper bound of the sales cycle index is (approximately) 365 days. Therefore, to convert the sales cycle index into percentage form, the sales cycle index is divided by 365 (or 366 in a leap year), and that result is subtracted from 1.

The non-index based prime measure may comprise the time to market index, which is expressed by a number of days. The upper bound is (approximately) 730 days (2 years). Therefore, to convert the time to market index may be converted into a percent by dividing it by 730 and subtracting that result from 1.

The non-index based prime measure may comprise the cash-to-cash cycle time, which is expressed by a number of days. The upper bound for the cash-to-cash cycle time is approximately 180 days. Therefore, to convert cash-to-cash cycle time to a percentage, it is divided by 180, and that result is subtracted from 1.

The present invention may be used for many useful management purposes and can support many different types of business tools and applications. In an example embodiment of the invention, at least one of the prime measures may be applied to at least one of return on investment analysis, linking vision to action, IT to business alignment, external reporting, strategic alliances, due diligence, incentive compensation plans, business activity monitoring, monitoring service level agreements, and supplier ratings.

The present invention may also be used to support a strategic planning method of the business using at least one of the prime measures. For example, the strategic planning method may comprise the well-known balanced scorecard method.

At least one of the calculated prime measures may be externally reported, for example to investors in a quarterly report or the like.

In an example embodiment of the invention, a computerized system is provided which is configured to implement the foregoing methods.

In one example embodiment, a system for evaluation of business performance is provided. The system includes a database for storing: (i) a plurality of business aspects, each of which represents a portion of actionable activities of a business; (ii) a plurality of aggregate measures for each business aspect, each of the aggregate measures comprising a set of related actionable activities for a respective business aspect; and (iii) a plurality of prime measures for each aggregate measure, each of the prime measures quantifying one or more actionable activities from the set of related actionable activities. A user interface is provided for enabling the selection of a subset of the plurality of prime measures for each respective aggregate measure which best defines that aggregate measure for the business. A processor is provided for calculating a value of at least one of the prime measures from at least one of the selected subsets to provide an indication of the business performance.

### BRIEF DESCRIPTION OF THE DRAWINGS

The present invention will hereinafter be described in conjunction with the appended drawing figures, wherein like reference numerals denote like elements, and:

FIG. 1 shows an example embodiment of the present invention;

FIG. 2 shows the positioning of an example embodiment of the present invention in relation to other performance measurement tools;

FIG. 3 shows a block diagram of an example embodiment of the invention;

FIG. 4 shows the relationship between specific business aspects and aggregate measures in an example embodiment of the invention; and

FIG. 5 shows the relationship between specific aggregate measures and prime measures in the example embodiment of FIG. 4.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

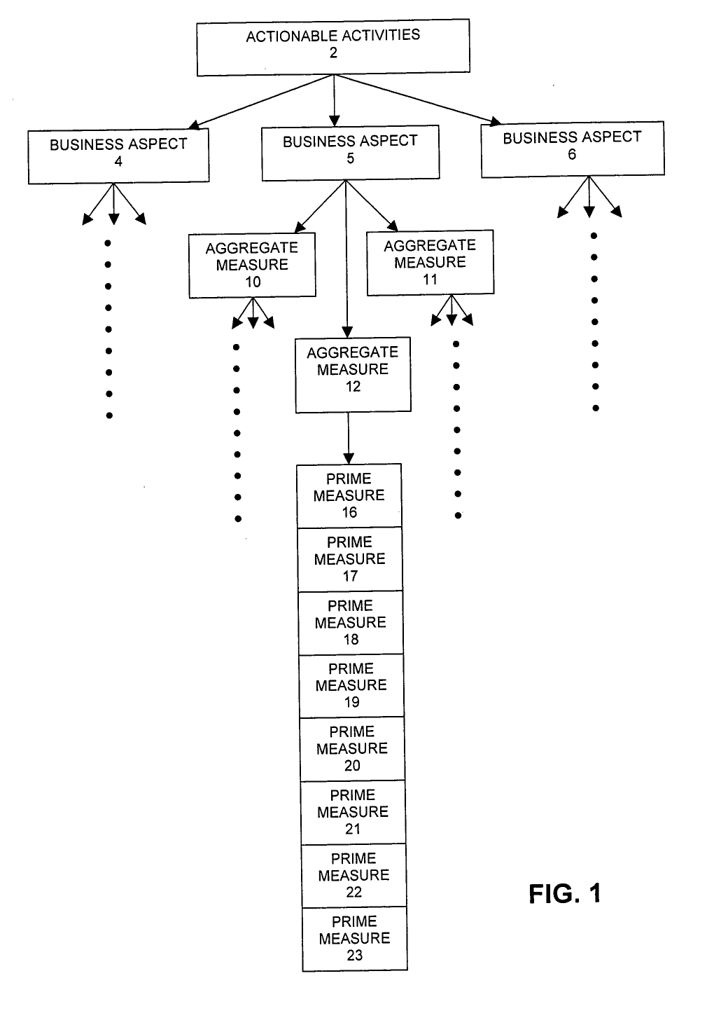

The present invention provides methods and systems for evaluation of business performance. In particular, the present invention provides a framework for use in evaluating business performance, which includes a set of precisely defined financial and non-financial metrics. As shown in FIG. 1, the framework is established by dividing all the actionable activities 2 of a business into a plurality of business aspects (e.g., business aspects 4, 5, and 6). A plurality of aggregate measures is then established for each business aspect (e.g., aggregate measures 10, 11, and 12 for business aspect 5). Each of the aggregate measures comprises a set of related actionable activities for a respective business aspect. A plurality of prime measures is established for each aggregate measure (e.g., prime measures 16-23 for aggregate measure 12). Each of the prime measures quantifies one or more actionable activities from the set of related actionable activities of the respective aggregate measure. A value of at least one of the prime measures may be calculated to provide an indication of business performance.

The value of at least one aggregate measure may then be calculated by multiplying the values of each of the prime measures for that aggregate measure together to provide an indication of business performance. For example, the value of prime measure 16 may be calculated to provide an indication of business performance. To provide an indication of overall business performance, the value of each aggregate measure for each business aspect may then be calculated by multiplying the values of each of the prime measures for that aggregate measure together. For example, to provide a value for aggregate measure 12, the values of each of the prime measures 16-23 may be calculated and then multiplied together. Similarly, the prime measures for aggregate measures 10 and 11 may be calculated and multiplied together to provide respective values for those aggregate measures. One the aggregate measures are calculated, the values may be multiplied together to provide an indication of overall business performance. However, it should be appreciated that, for certain industries, the aggregates may not be equally indicative of business performance. Therefore, weighting factors may be applied to each aggregate according to the industry of the organization, so that the product of the weighted values of the aggregate measures provides an indicator of overall business performance for the organization.

Those skilled in the art will appreciate that the particular number of business aspects, aggregate measures, and prime measures shown in the Figures are provided for example only. The invention may be implemented with different numbers of business aspects, aggregate measures and prime measures.

The present invention enables consideration of all aspects of an organization in order to determine the affect on overall business value of specific initiatives. As discussed above, the present invention is designed to apply to organizations in all industries. This is made possible by a flexible architecture consisting of aggregate and prime measures. For example, the organization can select a subset of the prime measures from the plurality of prime measures provided for each aggregate measure which are most appropriate for its industry and business model.

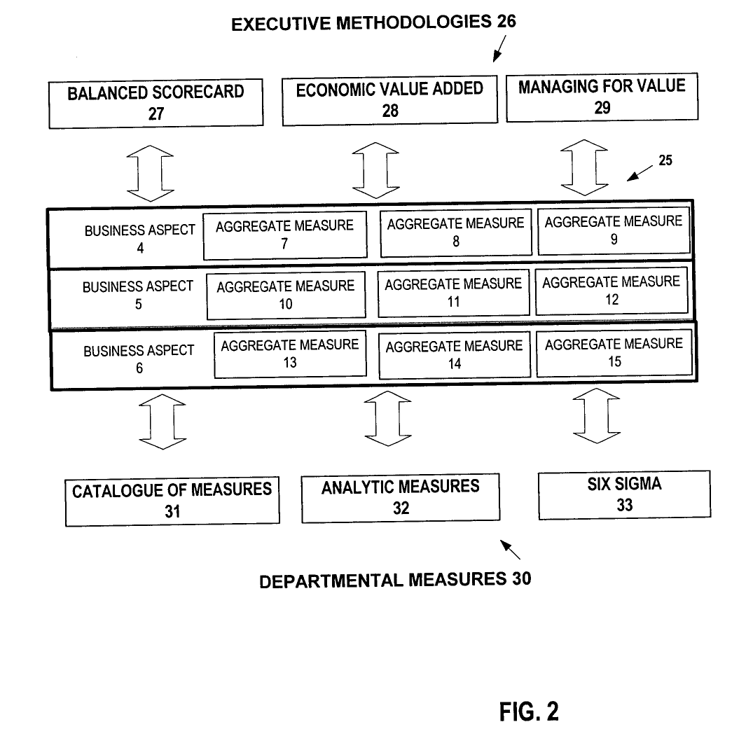

As shown in FIG. 2, the framework 25 provided by the present invention (business aspects 4, 5, and 6 and their respective aggregate measures 7-15 and primes (not shown)) is positioned to sit between well-known strategic methodologies 26 (e.g., such as Balanced Scorecard 27, Economic Value Added 28, and Managing for Value 29) and enterprise specific measurement tools and capabilities 30 (e.g., Catalogue of Measures 31, Analytic Measures 32, and Six Sigma 33). The present invention complements rather then competes with such other widely used methodologies and practices.

More important than the prime measures themselves is the process for selecting and maintaining them. Just as Financial Accounting Standards Board (FASB) in the US has generally accepted accounting principles, the framework of the present invention must also have principles or values that govern its evolution. The following are the generally accepted principles for the framework provided by the present invention, referred by the assignee as the Gartner Business Performance Framework™:

a. All metrics (both aggregate and prime) when used collectively are leading indicators of financial performance. Financial performance is defined as that performance which is measured by Generally Accepted Accounting Principles (GAAP).

b. No more than seven (plus or minus two) metrics are to be used at any given management level.

c. The metrics that make up the framework of the present invention should be collectively exhaustive and mutually exclusive with respect to measuring the actionable activities of an enterprise.

d. The framework should be hierarchical, focusing on the actionable activities within the enterprise that are managed at the executive and middle management levels. The framework need not go down to a detailed process or intradepartmental level (although mapping such metrics into the standard framework should be encouraged).

e. The framework should be based on standard prime metrics and foster collaboration and allow comparison to both internal and external entities.

f. The framework should be made flexible by an architecture allowing many combinations of both standard as well as custom prime metrics that are configured into aggregate measures. It is recommended that 70-80% of the metrics used in an enterprise implementation of the framework be standard, and 20-30% custom.

g. The holistic nature of the framework should capture the “cause” and “effect” relationships between business functions within the enterprise to insure that all the effects of a specific change are considered.

h. The prime metrics should be selected based on general availability in automated business transaction systems.

i. The framework should evolve and develop over time allowing benchmarking to continue throughout.

The concepts of collectively exhaustive and mutually exclusive mentioned in principle (c) above are straightforward. However, the implication of these concepts to performance management is powerful. Collectively exhaustive means that the set of measures identified explain all the actionable activities within the enterprise. This includes demand management, supply chain management, and support services. In this way, the framework is limited to the things management can affect. Similar to driving a car, you can control the steering wheel, gas and brake, but you can't control the weather, or direction of the road. Mutually exclusive means that no two measures overlap one another in terms of the operating events being monitored. Keep in mind that this needs to be true as you move both vertically as well as horizontally throughout the framework. Inventory-Turns and Inventory-Days-of-Supply are measures that overlap. Upon examination of the definitions of these two measures, it is clear that they are measuring the same thing.

The present invention is intended to provide many useful management purposes. The following table provides several examples of such management purposes.

| Appli- | | |
|---|---|---|
| cation | Description | Advantages |
| ROI | IT-based business initia- | Provides a complete view of |
| analysis | tives should be examined | effects of IT enabled |
| | based on a “Total Value | business initiatives. |
| | of Opportunity” metho- | |
| | dology, using a holistic | |
| | view of business performance. | |
| Linking | The invention provides natural | Lowers the risk and cost of |
| Vision to | support for the Balanced | implementing the business- |
| Action | Scorecard. | balanced scorecard by |
| | | providing the required |
| | | operational measures. |
| IT to | Translating vision to action | Provides a common language |
| Business | with precise measures esta- | between business executives |
| Alignment | blishes the link between | and IT professionals. |
| | business need and techni- | |
| | cal capabilities, | |
| External | Standard, auditable extensions | If certain prime measures |
| Reporting | to financial measures. Ob- | capture the relative |
| | viously caution is needed with | strengthens of your |
| | any additional external re- | organization, why not report |
| | porting, but more disclosure | them externally? |
| | lowers perceived risk and | |
| | adds shareholder value. | |
| Strategic | Common use present inven- | Complementary objectives |
| Alliances | tion provides more auditable | are easier to identify and |
| | information upon which to | build relationships from |
| | select partners. | using objective and |
| | | verifiable business measures. |
| Due | Precisely defined and audit- | Greater visibility into the |
| Diligence- | able information allows for | operating performance of the |
| Mergers | more rapid and accurate | business. |
| and | assessments of acquisition | |
| Acqui- | targets and makes acquisition | |
| sitions | candidates more attractive. | |
| Incentive | The principles of the present | As leading indicators of |
| Compen- | invention emphasize the dis | financial results, the |
| sation | tribution of only a few mea- | performance measures make |
| Plans | sures to the functional areas | ideal targets for incentive |
| | managing their results. | compensation plans. |
| Business | Periodic updates on business | The invention provides the |
| Activity | performance are no longer | necessary measures upon |
| Monitor- | acceptable in many competi- | which exceptional |
| ing | tive environments, Monitoring | performance can be |
| (BAM) | critical business processes for | monitored. |
| | exceptional performance is an | |
| | emerging response to the need | |
| | for more agile, cost | |
| | effective enterprises. | |
| Monitor- | Business Process Outsourcing | Expands the focus of SLA's |
| ing | requires business focused | beyond tactical to strategic, |
| Service | measurement for both partners | increasing the long-term |
| Level | to succeed | success of outsourcing |
| Agree- | | relationships. |
| ments | | |
| Supplier | Moody's rates bonds for | In addition to forming the |
| Ratings | investors. An auditable set of | basis of Service Level |
| | operational performance mea- | Agreements, the invention |
| | sures could be used to rate | could be used to select |
| | product and service providers, | suppliers. Suppliers could |
| | | also use the invention to |
| | | differentiate their |
| | | capabilities. |

Is important to recognize that not all prime metrics will apply to all organizations. Additionally, the prime metrics that are appropriate for particular organizations may change over time. As a result, it is essential that organizations undertake a systematic and rigorous process to identify which prime metrics are most relevant to them.

The principles listed above were followed to validate initial selection of aggregate measures and prime measures for use with the present invention. Those skilled in the art should appreciate that the particular aggregate measures and prime measures defined herein are subject to change. Existing aggregate measures and prime measures may be modified for use with a particular business. Further, new aggregate measures and prime measures may be defined in accordance with changing business environments and needs.

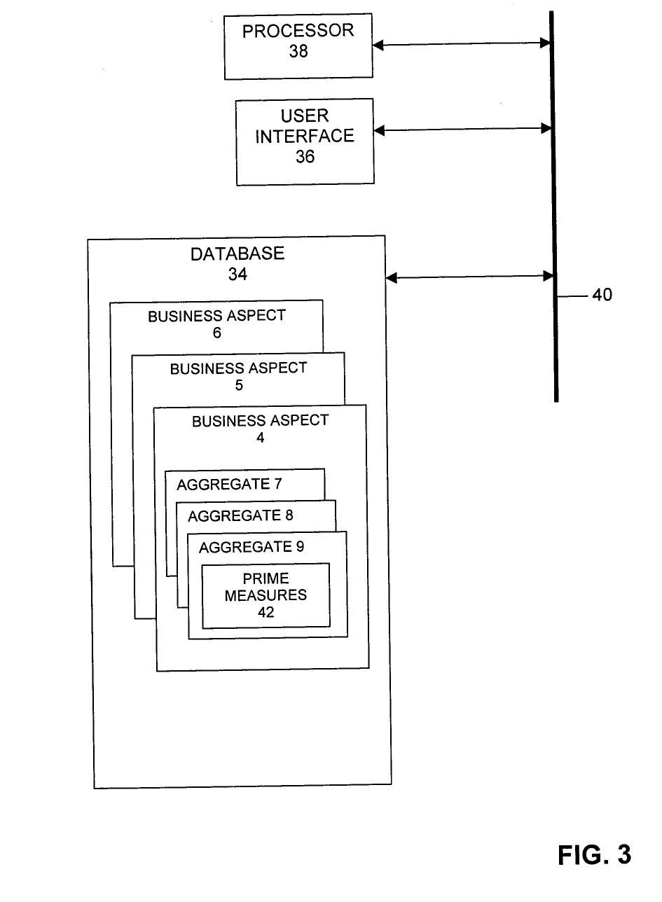

In an example embodiment of the invention as shown in FIG. 3, a database 34 is provided for storing: (i) a plurality of business aspects 4, 5, 6, each of which represents a portion of actionable activities of a business; (ii) a plurality of aggregate measures for each business aspect (e.g., aggregate measures 7, 8, and 9 for business aspect 4), each of the aggregate measures comprising a set of related actionable activities for a respective business aspect; and (iii) a plurality of prime measures for each aggregate measure (e.g., prime measures 42 for aggregate measure 9), each of the prime measures quantifying one or more actionable activities from the set of related actionable activities. A user interface 36 is provided for enabling the selection of a subset of the plurality of prime measures for each respective aggregate measure which best defines that aggregate measure for the business. A processor 38 is provided for calculating a value of at least one of the prime measures from at least one of the selected subsets to provide an indication of the business performance. The interface 36, processor 38, and the database 34 communicate with one another via a network 40.

The user interface 36 may comprise a personal computer, a web browser running on an Internet appliance, or the like. The database 34 may be stored locally, for example on a hard drive of a personal computer. Alternatively, the database 34 may be a remote database which is accessible via the network 40, such as a local area network, a wide area network, a global area network, the Internet, or the like. The processor 38 may comprise a processor on a personal computer, a processor running on a remote server, or the like. The present invention may be implemented in software, hardware and firmware on a personal computer, or may be provided in the form of a software application provided by an application service provider via a network.

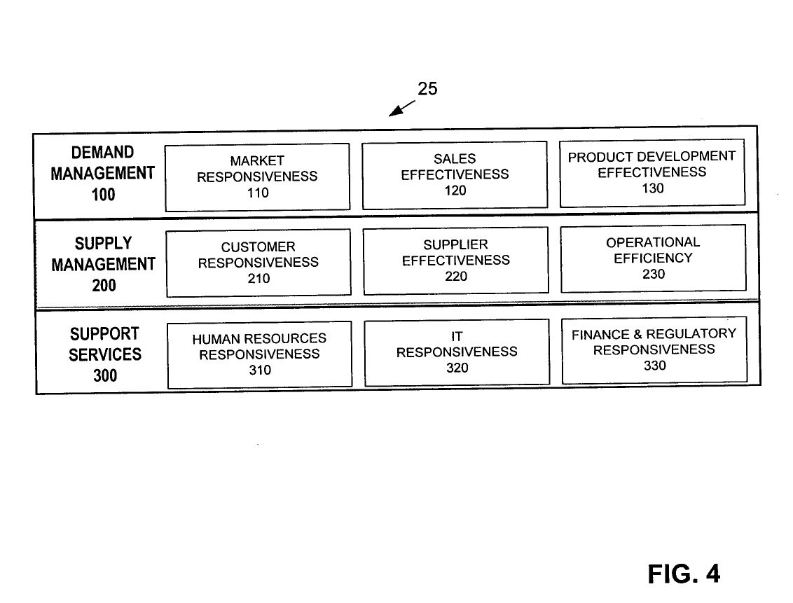

In an example embodiment of the invention as shown in FIG. 4, three business aspects may be provided: A demand management business aspect 100, which includes all the actionable activities involved with generating demand for the products and services offered by the organization; a supply management business aspect 200, which includes all the actionable activities directly involved with satisfying demand for the products and services offered by the organization; and a support services business aspect 300, which includes all other actionable activities involved with supporting the organization. The support services are services which operate within organizations by providing services to internal clients. They operate on business principles and provide internal services at a cost and quality that is acceptable to its clients, when assessed against alternatives.

The aggregate measures are grouped by high-level business aspect. In the example embodiment of the invention shown in FIG. 4, the demand management business aspect 100 may include the following aggregate measures: market responsiveness 110, sales effectiveness 120, and product development effectiveness 130. The supply management business aspect 200 may include the following aggregate measures: customer responsiveness 210, supplier effectiveness 220, and operational efficiency 230. The support services business aspect 300 may include the following aggregate measures: human resources responsiveness 310, information technology responsiveness 320, and finance and regulatory responsiveness 330.

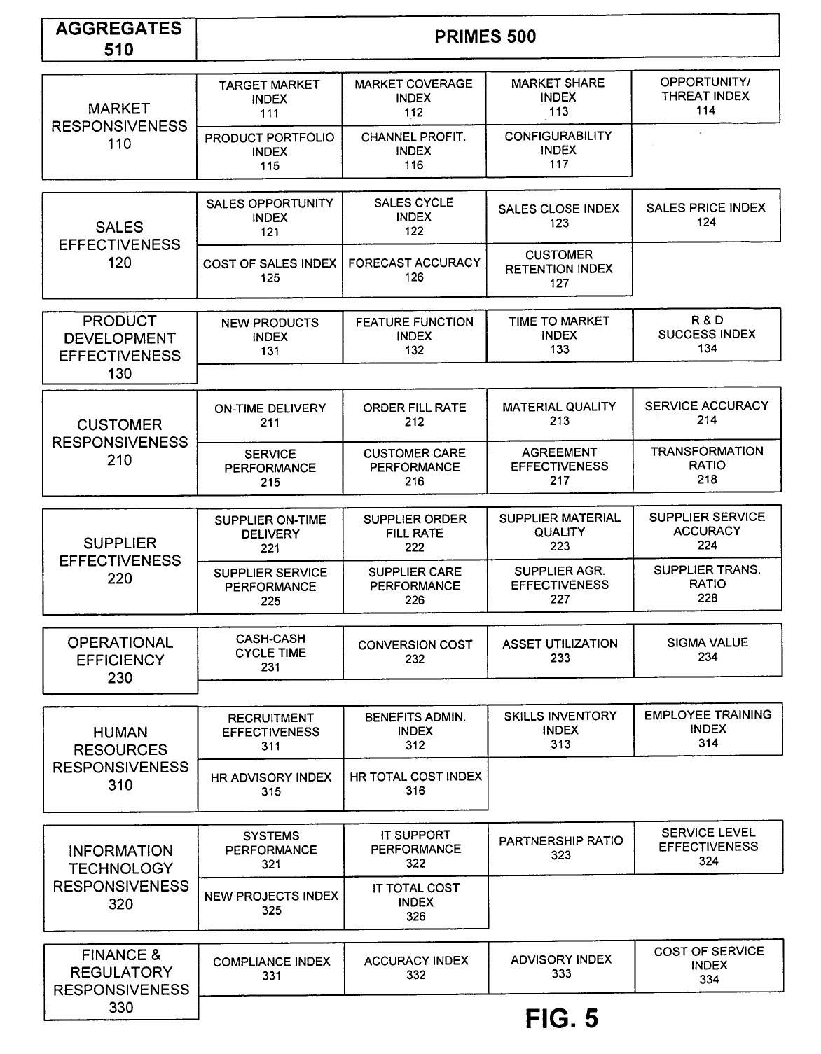

As mentioned previously, the present invention is designed to apply to all organizations in all industries. This is made possible by a flexible architecture consisting of the aggregate and prime measures. Following the principles outlined above, an organization may select a subset of prime measures from among a pool of candidate prime measures provided for each aggregate measure those measures that appropriately define each of the aggregates for a particular organization. In an example embodiment of the invention shown in FIG. 5, the candidate list of prime measures 500 is grouped by the aggregate measures 510 they define. Each aggregate measure and each of the candidate prime measures for the respective aggregate measures shown in FIGS. 4 and 5 will be defined in detail below.

The activities measured by the market responsiveness aggregate measure 110 are entirely contained within the business aspect of demand management 100. The activities measured by market responsiveness 110 are distinct from the other aggregates within the demand management business aspect 100. The activities measured by market responsiveness 100 involve identifying and validating customer needs, now and projected into the future, in current and targeted markets (driven by the strategic plan business plan of the organization), identifying and validating competitive opportunities/threats in those markets, developing and delivering appropriate messages (branding) to convey the value of the goods and services offered by the organization.

The activities measured by the market responsiveness aggregate measure 110 affect virtually all aspects of the organization. Driven by the strategic plan for the organization, market responsiveness begins to translate and shape that plan into actionable, measurable activities. Knowing your customers and “keeping your friends close and your enemies closer” is what drives the operational activities of most businesses.

The value of the market responsiveness aggregate measure 110 varies by organization and industry. In general, the more competitive or volatile a market is, the more significant market responsiveness becomes. An industry example is consumer-packaged goods (CPG). Demand market responsiveness may have the single biggest affect on financial performance from among all the aggregate measures for these types of products.

The prime measures associated with the market responsiveness aggregate measure 110 may include target market index 111, market coverage index 112, market share index 113, opportunity/threat index 114, product portfolio index 115, channel profitability index 116, and configurability index 117.

The activities measured by the sales effectiveness aggregate measure 120 are entirely contained within the demand management business aspect 100. The activities measured by sales effectiveness 120 are distinct from the other aggregates within this business aspect. The activities measured by sales effectiveness 120 involve optimizing all customer (including potential customers and prospects) relationships based on the marketing message and unique capabilities of the organization. Included in these activities is the providing of information used to forecast specific customer needs for the products and services offered by the organization.

The activities measured by the sales effectiveness aggregate measure 120 are required by all organizations offering products and services to independent customers. Customer relationships are the most important relationships in an organization. Managing them effectively in changing environments is essential to the success of the organization.

An acceptable level of sales effectiveness is essential in all organizations and industries. Even in a monopoly (such as a local cable company in the U.S.) must be concerned with sales effectiveness, because disenfranchised customers will find alternatives at some point. Sales effectiveness 120 is a necessary condition for organizational success.

The prime measures associated with sales effectiveness 120 may include sales opportunity index 121, sales cycle index 122, sales close index 123, sales price index 124, cost of sales index 125, forecast accuracy 126, and customer retention index 127.

The activities measured by the product development effectiveness aggregate measure 130 are entirely contained within the demand management business aspect 100. The activities measured by product development effectiveness 130 are distinct from the other aggregates within this business aspect. The activities measured by product development effectiveness 130 involve creating new capabilities, products or services, or reorganizing existing capabilities offered by the organization to meet the changing needs (customer needs are identified under the market responsiveness aggregate measure discussed above) of the customers to be served in new targeted markets or currently being served in existing markets.

All organizations must innovate to remain competitive. In free markets, the only constant is change. An organization's ability to address and sometimes even create changes in the markets it participates in will have a significant effect on its future success.

The value of product development effectiveness 130 varies by organization and industry. In general, the more differentiated the goods and services within a market, the more value product development effectiveness has. Examples are high technology and pharmaceutical products. The product development effectiveness aggregate measure 130 may have the single biggest affect on financial performance from among all the aggregate measures for these types of products.

The prime measures associated with product development effectiveness 130 may include new products index 131, feature function index 132, time-to-market index 133, and research and development success index 134.

The activities measured by the customer responsiveness aggregate measure 210 are entirely contained within the supply management business aspect 200. Activities measured by customer responsiveness 210 are distinct from the other aggregates within this business aspect. The activities measured by customer responsiveness 210 are all the activities directly involved with completing a specific customer order or service and providing visibility into the status of completing a specific order or service. Customer responsiveness 210 is the point at which demand management affects supply management. Customer responsiveness 210 drives the other supply management aggregates.

Customer satisfaction is significantly affected by the activities measured by customer responsiveness 210. It is the point at which the organization either meets or fails to meet the expectations of its customers that were established by the demand management activities. The level of performance of customer responsiveness 210 can also significantly affect operational costs.

The value of customer responsiveness 210 varies by organization and industry. In general, the more competitive a market is, the more significant customer responsiveness 210 becomes. Using an earlier example, customer responsiveness 210 has tremendous impact in the consumer-packaged goods (CPG) industry.

The prime measures associated with customer responsiveness 210 may include on-time delivery 211, order fill rate 212, material quality 213, service accuracy 214, service performance 215, customer care performance 216, agreement effectiveness 217, and transformation ratio 218.

The activities measured by the supplier effectiveness aggregate measure 220 are entirely contained within the business aspect called supply management 200. Activities measured by supplier effectiveness 220 are distinct from the other aggregates within this business aspect. The activities measured by supplier effectiveness 220 include all the activities directly involved with completing a specific purchase order and providing visibility into the status of completing a specific order or service. Supplier effectiveness 220 covers all procurement needs, including direct and in-direct materials as well as services.

The activities measured by the supplier effectiveness aggregate measure 220 can represent the largest category of annual costs for an organization. The difference between profit and loss is driven by supplier effectiveness in many industries. Even in industries where procurement activities have less impact, supplier effectiveness 220 can be the difference between success and failure with specific engagements.

The value of the supplier effectiveness aggregate measure 220 varies by industry. In general, competitive, commodity product companies and markets are affected most by supplier effectiveness 220.

The prime measures associated with the supplier effectiveness aggregate measure 220 may include supplier on-time delivery 221, supplier order fill rate 222, supplier material quality 223, supplier service accuracy 224, supplier service performance 225, supplier customer care performance 226, supplier agreement effectiveness 227, and supplier transformation ratio 228.

The activities measured by the operational efficiency aggregate measure 230 are entirely contained within the supply management business aspect 200. Activities measured by operational efficiency 230 are distinct from the other aggregates within this business aspect. The activities measured by operational efficiency 230 are those value-added activities performed internally to create the goods and services offered by the organization, including the material requirements planning and optimization of resources. Coordinating and integrating out-sourced business functions is also part of operational efficiency.

The activities measured by the operational efficiency aggregate measure 230 define the core competency of the organization. As organizations out-source more of their business functions, the range of activities covered by operational efficiency may decline, but the activities surrounding the coordination and integration of these out-sourced functions increases in importance.

The value of operational efficiency 230 varies by organization and industry. In general, the more differentiated and complex the products and services are, the more significant operational efficiency becomes. Using an earlier example, operational efficiency 230 in the high technology and pharmaceutical industries is among the most significant aggregate measures of financial success.

The prime measures associated with the operational efficiency aggregate measure 230 may include cash-to-cash cycle time 231, conversion cost 232, asset utilization index 233, and sigma value 234.

Each of the aggregate measures within the support services business aspect 300 (e.g., human resources responsiveness 310, information technology responsiveness 320, and finance and regulatory responsiveness 330) assumes that the activities covered are managed through Service Level Agreements (SLAs) with internal customers. These SLAs are based on the demand and supply management issues of the support service provided (which effectively defines a business within a business). What is unique to the aggregate measure for each of the support services categories is the nature of the services provided.

The services measured by human resources responsiveness 310 are distinct from the other aggregate measures within the support services business aspect 300. The services measured by human resources responsiveness 310 involve recruitment, training, employee development, organized labor relations and employee satisfaction.

The activities measured by the human resources responsiveness aggregate measure 310 represent the organization's general ability to deal with changing requirements of its work force.

The value of human resources responsiveness 310 varies by organization and industry. In general, the more service oriented the organization is, the more value human resources responsiveness has.

The prime measures associated with the human resources responsiveness aggregate measure 310 may include recruitment effectiveness index 311, benefits administration index 312, skills inventory index 313, employee training index 314, human resources advisory index 315, and human resources total cost index 316.

The services measured by the information technology (IT) responsiveness aggregate measure 320 are distinct from the other aggregate measures within the support services business aspect 300. The services measured by IT responsiveness 320 involve the effectiveness, reliability, enablement of collaborative business relationships, and agility of IT resources in an organization.

The activities measured by the IT responsiveness aggregate measure 320 represent the organizations general ability to exploit information technology and deal with changing requirements of it's IT resources.

The value of IT responsiveness 320 varies by organization and industry. In general, the higher the volume of transactional activity and the more complex the services are, the more value IT responsiveness 320 will have.

The prime measures associated with IT responsiveness 320 may include systems performance 321, IT support performance 322, partnership ratio 323, service level effectiveness 324, new project index 325, and IT total cost index 326.

The services measured by the finance and regulatory responsiveness aggregate measure 330 are distinct from the other aggregate measures within the support services business aspect 300. The services measured by finance and regulatory responsiveness aggregate measure 330 involve transactional activities (non-strategic activities) in the following functions: finance, treasury, travel, real estate, legal, and regulatory.

The activities measured by finance and regulatory responsiveness aggregate measure 330 represent the organization's general ability to deal with administrative requirements cost effectively.

The value of the finance and regulatory responsiveness aggregate measure 330 varies by organization and industry. In general, the more regulated the industry is, the more value the finance and regulatory responsiveness aggregate measure 330 has. An example would be the pharmaceutical or medical device industry.

The prime measures associated with the finance and regulatory responsiveness aggregate measure 330 may include compliance index 331, accuracy index 332, advisory index 333, and cost of service index 334.

The financial implications of each aggregate measure vary by organization and industry. Once an organization has selected the appropriate prime measures from among the pool available for the particular aggregate measure, the baseline performance and financial impact of changes to the particular aggregate measure can be determined.

Each of the candidate prime measures 500 shown in FIG. 5 will be discussed in detail below. Sample calculations for each prime measure will also be provided. Those skilled in the art should appreciate that the candidate prime measures 500 shown in FIG. 5 are exemplary only. Further, the definitions and calculations provided below are flexible and may be changed to better accommodate a particular industry or business. Additional prime measures may be added to the candidate list shown in FIG. 5. Further, an organization may also use one or more standard prime measures currently defined in the prior art in addition to the prime measures identified herein. The activities measured by each prime measure described below are distinct from the other prime measures within that same aggregate.

Target Market Index 111

Activities measured by the target market index prime measure 111 are entirely contained within the scope of the market responsiveness aggregate measure 110. The activities measured by target market index 111 reflect the decisions made by the organization regarding the size and growth rates of the markets it participates in.

The target market index 111 for an organization may be calculated as follows: Select the appropriate target market industries (based on current product/service offerings as well as planned and budgeted offerings over the next twelve months) using International Standard Industrial Classification (ISIC) codes (cross-referenced to Standard Industrial Classification (SIC) codes and North American Industrial Classification System (NAICS) codes). Multiply the relative market size (sum of revenue in target market industries divided by normalized industry revenue) times 1 plus relative market growth rate (weighted average growth rate of all the targeted industries).

As an example, the target market index 111 for XYZ Computer Corporation, a computer systems company may be calculated as follows: Using the ISIC industry classification system, the appropriate Target Market industry for XYZ is ISIC 3825 Office & Computing Machinery. Multiplying the relative market size times the relative market growth rate yield the following target market index for XYZ Computer Corporation (all $ in millions):

Relative market size=(457,322.15/451,712.70)=1.0124

1 plus relative market growth rate=1+(−0.04)=0.96

Target Market Index=(1.0124×0.96)=0.9719

Adjusted quarterly, the target market index 111 is an indication of the market potential for the products and services offered by the organization. This prime measure is significantly influenced by the forecasted growth rate of the industries the organization participates in. The income statement account most affected by target market index 111 is revenue. The size and rate of growth of the market(s) the organization participates sets the boundaries for future revenue potential.

The prime measures which may be affected by a change in the target market index 111 include market coverage index 112, market share index 113, opportunity/threat index 114, sales cycle index 122, sales close index 123, and new products index 131.

Market Coverage Index 112

Activities measured by the market coverage index prime measure 112 are entirely contained within the scope of the market responsiveness aggregate measure 110. The activities measured by market coverage index 112 involve the reach of the sales function to generate revenue in geographic locations where demand for the products and services offered by the organization exists.

The market coverage index 112 for an organization may be calculated as follows: Select the appropriate target market industries (based on current product/service offerings) using ISIC codes (cross-referenced to SIC and NAICS codes). Divide the number of countries in which the organization has sold its products or services by the total number of countries where revenue exists for the industries selected.

This prime measure requires access to internal information, so the following example calculation of market coverage index 112 is based on an imaginary organization called MY Company. MY Company sells PC hardware components in 16 countries around the world. Last year 59 countries reported revenue in the Office & Computing Machinery Computer industry (ISIC 3825) yielding the following market coverage index:

Market Coverage Index=(16/59)=0.27

The definition of market coverage index 112 may be modified to provide for weighting of the industry revenue for each country, which may make this prime measure more meaningful.

Adjusted quarterly, this measure is an indication of the sales function's ability to reach customers in remote locations. This measure does not require a physical presence in the country where the sale occurs.

The income statement account most affected by market coverage index 112 is revenue. Market coverage is relevant as recent trade agreements and improvements in communication technology have broadened economic boundaries. Further, opportunities to sell existing products and services in new markets will increase over time.

The prime measures which may be affected by a change in market coverage index 112 include market share index 113, product portfolio index 115, sales opportunity index 121, sales cycle index 122, sales close index 123, sales price index 124, cost of sales index 125, forecast accuracy index 126, on-time delivery 211, and service accuracy 214.

Market Share Index 113

Activities measured by the market share index prime measure 113 are entirely contained within the scope of the market responsiveness aggregate measure 110. The activities measured by market share index 113 involve the relative strength and influence of the organization in the markets it currently participates in.

The market share index 113 may be calculated as follows: Select the appropriate industry(s) (based on current product/service offerings) using ISIC codes (cross-referenced to SIC and NAICS codes). Divide the revenue of the products and services offered by the organization by the total revenue of the selected industries.

As an example, market share index 113 may be calculated for XYZ Computer Corporation, a computer systems company, as follows: Using the ISIC industry classification system, the appropriate industry for XYZ is ISIC 3825 Office & Computing Machinery. Dividing the revenue of the products and services for XYZ by the total revenue of this industry yields the following (all $ in millions):

Market Share Index=(31,170.00/457,322.15)=0.07

Adjusted quarterly, this measure is an indication of the organization's strength and influence in the markets it participates in. market share index is useful for determining important business strategies such as pricing.

The income statement account most affected by market share index 113 is revenue. Calculating market share using an agnostic, comparable and auditable process like the market share index makes this important measure useful.

The prime measures which may be affected by a change in the market share index 113 include opportunity/threat index 114, sales cycle index 122, sales close index 123, forecast accuracy index 126, and new products index 131.

Opportunity/Threat Index 114

Activities measured by the opportunity/threat index prime measure 114 are entirely contained within the scope of the market responsiveness aggregate measure 110. The activities measured by opportunity/threat index 114 involve the potential to expand or the risk of losing market share index based on the level of competition in the industries the organization participates.

The opportunity/threat index 114 may be calculated as follows: Select the appropriate target market industries (based on current product/service offerings as well as planned and budgeted offerings over the next twelve months) using ISIC codes (cross-referenced to SIC and NAICS codes). Sum the market share index (see market share index calculation given above) for the top five competitors in the selected industries.

An example calculation of the opportunity/threat index 114 for XYZ Computer Corporation, a computer systems company, is as follows: Using the ISIC industry classification system, the appropriate target market industry for XYZ is ISIC 3825, Office & Computing Machinery. Summing the market share index of the top five competitors in this industry yields: the following Opportunity/Threat Index (all $ in millions):

Market Share Index for Dell=((31,170.00/457,322.15)=0.07

Market Share Index for Compaq=((26,73.0.55/457,322.15)=0.06

Market Share Index for HP=(18,934.14/457,322.15)=0.04

Market Share Index for IBM=(13,365.27/457,322.15)=0.03

Market Share Index for NEC=(7,796.41/457,322.15)=0.02

Opportunity/Threat Index=(0.07+0.06+0.05+0.03+0.02)=0.23

Adjusted quarterly, this measure is an indication of the organizations potential to expand or the risk of losing market share index. The greater the number of competitors, each with a small market share index, the higher the opportunity to expand market share index and the higher the threat of losing market share index to a competitor. In the example above, opportunity/threat for XYZ Computer Corporation is medium.

The income statement account most affected by opportunity/threat index 114 is revenue. The opportunity/threat index 114 measures the competitive structure of the industry(s) the organization participates in and the influence this structure can have on future revenue.

The prime measures which may be affected by a change in the opportunity/threat index 114 include target market index 111, market share index 113, product portfolio index 115, sales cycle index 122, sales close index 123, forecast accuracy index 126, and new products index 131.

Product Portfolio Index 115

Activities measured by the product portfolio index prime measure 115 are entirely contained within the scope of the market responsiveness aggregate measure 110. The activities measured by product portfolio index 115 involve identifying and validating customer needs, now and projected into the future, in current and targeted markets. This metric shows the product portfolio by size and margin contribution. The underlying assumption is that products with higher margins indicate that they are serving customer needs better than low margin products, and that high growth rates also indicate that customer needs are being met. The index combines these separate factors to come up with an overall metric that indicates the ability of the company to serve customer needs when compared to its industry peers.

The product portfolio index 115 may be calculated as follows: Organize the current product/service offerings into four quadrants on a grid based on the following procedure: First, determine the current product or service with the highest growth rate in annual revenue. Divide the growth rate of this product or service by 2. Determine the current product or service with the highest gross margin in absolute dollar terms (not percentage). Divide the dollar gross margin figure by 2. Build the quadrant starting with 0,0 in the lower left corner with the gross margin figures (½ followed by highest) labeled on the horizontal axis, and growth rate (½ followed by highest) on the vertical axis. Extend the points horizontally and vertically to complete the grid. Plot all remaining product/services currently offered by the organization based on their respective growth rates and gross margins in dollar terms. The product portfolio index is calculated by dividing the total revenue of the products and services in all quadrants, except the lower left quadrant, by the total revenue of the organization. This prime measure requires access to internal information. As an example calculation of the product portfolio index 115, assume that MY Company has four service offerings called: Service 1, 2, 3 and 4. Last year the gross margin (in absolute dollar terms) and growth rates for the four service offerings were as follows (all $ in millions):

Service 1: Gross Margin 100 Growth Rate 0.05

Service 2: Gross Margin 10 Growth Rate 0.12

Service 3: Gross Margin 150 Growth Rate 0.01

Service 4: Gross Margin 20 Growth Rate 0.07

Product Portfolio Index=1.00 (obtained by plotting the foregoing gross margin and growth rate values for each service 1-4 on a grid as described above, and summing the total revenue in all quadrants except the lower left quadrant and then dividing by the total revenue to provide the product portfolio index.

Adjusted quarterly, this measure is an indication of the organization's ability to accurately determine the changing demands of current and potential customers. The income statement account most affected by product portfolio index 115 is gross profit. This prime measure is useful, as growth and income are what investors look for in organizations.

The prime measures which may be affected by a change in the product portfolio index 115 include market share index 113, opportunity/threat index 114, sales cycle index 122, sales close index 123, forecast accuracy index 126, and new products index 131.

Channel Profitability Index 116

Activities measured by the channel profitability index prime measure 116 are entirely contained within the scope of the market responsiveness aggregate measure 110. The activities measured by channel profitability index 116 involve identifying and evaluating alternative methods for reaching and servicing customers in current and targeted markets.

The channel profitability index 116 may be calculated as follows: Determine all the direct costs associated with supporting each sales channel (commissions, dealer discounts, finders fees, internal support costs, and the like). Sum the total cost of each channel and divide by the company's total revenue. Subtract this result from 1.

This prime measure requires access to internal information. As an example of channel profitability index 116, assume that MY Company distributes its products through two sales channels, a direct sales force and through distributors. The total cost for each channel is as follows (all $ in millions):

Direct Sales Force=$15

Distributors=$25

MY company's total revenue is therefore $125.

Channel Profitability Index=1−((15+25)/125)=0.68

Adjusted monthly, this measure is an indication of the organization's ability to utilize the most profitable channels for generating revenue. The income statement account most affected by channel profitability index is gross profit. Channel profitability is becoming an area of focus with the reduction in cost made possible through self-sufficient Internet channels.

The prime measures which may be affected by a change in the channel profitability index 116 include market share index 113, opportunity/threat index 114, configurability index 117, market coverage index 112, sales cycle index 122, sales close index 123, and cost of sales index 125.

Configurability Index 117

Activities measured by the configurability index prime measure 117 are entirely contained within the scope of the market responsiveness aggregate measure 110. The activities measured by the configurability index 117 involve the ability of the organization to identify and satisfy the specific needs of customers in current and targeted markets.

The configurability index prime measure 117 may be calculated as follows: Determine the total revenue generated from options offered on the products and services offered by the company during the previous twelve months and divide this number by total company revenue. An “option” is defined as a feature or function that must be purchased as part of a basic product or service and that is not required for the basic product or service to function.

This prime measure requires access to internal information. As an example calculation of configurability index 117, assume that MY Company offers a standard product line for all products except its personal computer line. The revenue generated from the options offered on the personal computer line during the prior twelve months was $5 million. The total company revenue was $125 million during this period (all $ in millions):

Revenue from options=$5

MY company's total revenue is $125.

Configurability Index=(5/125)=0.04

The definition of configurability index 117 may be modified to eliminate pricing policy issues. For example, the definition may be modified so that the total standard cost of each option divided by total cost-of-goods (services) sold provides the configurability index.

Adjusted monthly, this measure is an indication of the organization's ability to identify and satisfy the specific needs of customers in current and targeted markets. The income statement account most affected by configurability index 117 is revenue. This prime is relevant since mass-customization has become an effective marketing approach to aligning the products and services offered by the organization with the needs of the customers it serves.

The prime measures which may be affected by a change in the configurability index 117 include market share index 113, opportunity/threat index 114, sales cycle index 122, sales close index 123, cost of sales index 125, on-time delivery 211, order fill rate 212, material quality 213, service accuracy 214, and sigma value 234.

Sales Opportunity Index 121

Activities measured by the sales opportunity index prime measure 121 are entirely contained within the scope of the sales effectiveness aggregate measure 120. The activities measured by sales opportunity index 121 involve how successfully the organization can cultivate prospects (or suspects) for the products and services offered by the organization.

This prime measure requires a formal sales tracking process to exist within the organization that records and tracks the level of potential customers that have come in contact with the organization (entered a store, visited the on-line purchasing section of a web-site, responded to an ad, etc). Using the tracking system, determine the total contacts for each of the past twelve months. The sales opportunity index 121 may then be calculated by dividing the most recent monthly total by the twelve-month rolling average times 2.

This prime measure requires access to internal information. As an example calculation of sales opportunity index 121, assume that last year MY Company implemented a sales force automation system that tracks active prospective customers from initial contact to sales close or inactivity. Using the data available from this system, MY Company determined the total number of contacts with potential customers to be 7500 for the pervious twelve months. The total number for the most recent month was 800.

Sales Opportunity Index=800/((7500/12)*2)=0.64

The definition of sales opportunity index 121 may be modified to improve the ability to compare results between companies by changing the calculation to be the number of sales contacts divided by gross revenue per customer.

Adjusted monthly, this measure is an indication of the sales function's ability to cultivate sales opportunities. The income statement account most affected by sales opportunity index 121 is revenue. The sales opportunity index 121 is a leading indicator of the level of demand for the products and services offered by the organization.

The prime measures which may be affected by a change in the sales opportunity index 121 include market share index 113, product portfolio index 115, sales cycle index 122, sales close index 123, sales price index 124, and forecast accuracy index 126.

Sales Cycle Index 122

Activities measured by the sales cycle index prime measure 122 are entirely contained within the scope of the sales effectiveness aggregate measure 120. The activities measured by sales cycle index 122 involve the ability of the sales function to manage the duration of the sales process.

This prime measure requires a formal sales tracking process to exist within the organization that records when initial contacts with prospective customers are made. Using this sales tracking system, the sales cycle index 122 may be calculated by determining the average monthly duration (in calendar days) between the sales close date (successful or inactive) and initial contact.

This prime measure requires access to internal information. As an example of sales cycle index 122, assume that last year MY Company implemented a sales force automation system that tracks active prospective customers from initial contact to sales close or inactivity. Using the data available from this system, MY Company determined the sales cycle index by starting with the sales campaigns that had been closed during the month (either successfully or through inactivity). Tracing back to date of initial contact for each of these campaigns, the average monthly duration was 90 days.

Sales Cycle Index=90 days

The definition of sales cycle index 122 may be modified to improve the ability to compare results between companies. Such a modified calculation for the sales cycle index may involve dividing the current definition of this measure by average deal size.

Adjusted monthly, this measure is an indication of the sales function's to manage the duration of the sales process. The income statement account most affected by sales cycle index 122 is revenue. The sales cycle index 122 is a leading indicator of the level of demand for the products and services offered by the organization.

The prime measures which may be affected by a change in the sales cycle index 122 include market share index 113, product portfolio index 115, sales close index 123, and forecast accuracy index 126.

Sales Close Index 123

Activities measured by the sales close index prime measure 123 are entirely contained within the scope of the sales effectiveness aggregate measure 120. The activities measured by sales close index 123 involve how successfully the sales function can turn prospects to customers.

This prime measure requires a formal sales tracking process to exist within the organization that records and tracks all contacts with active prospective customers through to final buying decision. Using this sales tracking system, the sales close index 123 may be calculated by determining the monthly ratio of successful sales decisions to total decisions made by prospective customers.

This prime measure requires access to internal information. As an example calculation of sales close index 123, assume that last year MY Company implemented a sales force automation system that tracks active prospective customers from initial contact to sales close or inactivity. Using the data available from this system, MY Company determined the sales close index by dividing the number of successful sales campaigns (100) by the total sales campaigns closed (either successfully or through inactivity) during the month (175).

Sales Close Index=(100/175)=0.57

Adjusted monthly, this measure is an indication of the sales function's ability to turn prospects into customers. The income statement account most affected by sales close index 123 is revenue. The sales close index 123 is a leading indicator of the level of demand for the products and services offered by the organization.

The prime measures which may be affected by a change in the sales close index 123 include market share index 113, product portfolio index 115, sales cycle index 122, and forecast accuracy index 126.

Sales Price Index 124

Activities measured by the sales price index prime measure 124 are entirely contained within the scope of the sales effectiveness aggregate measure 120. The activities measured by sales price index 124 involve how successfully the sales function can close business at desired price levels.

The sales price index 124 may be calculated as follows: Determine the total discounts for all the items sold during the previous month. Divide this number by what total potential revenue would have been without any discounts (list pricing). Subtract this number from 1.

This prime measure requires access to internal information. As an example calculation of sales price index 124, assume that last month MY Company determined that the total discounts given on revenue earned was $1.58 million. Total revenue earned was $10.42 million. The total revenue of $10.42 plus discounts of $1.58 means total potential revenue was $12 (all $ in millions).

Sales Price Index=1−(1.58/12)=0.87

Adjusted monthly, this measure is an indication of the sales function's ability to sell product without dropping price and margin. The income statement account most affected by sales price index is revenue. The sales price index 124 is a leading indicator of the level of demand for the products and services offered by the organization.

The prime measures which may be affected by a change in the sales price index 124 include sales cycle index 122, sales close index 123, and cost of sales index 125.

Cost of Sales Index 125

Activities measured by the cost of sales index prime measure 125 are entirely contained within the scope of the sales effectiveness aggregate measure 120. The activities measured by cost of sales index 125 involve how cost efficiently the sales function can turn prospects to customers.

The cost of sales index 125 may be calculated as follows: Determine total sales expenses for the previous month. Divide this figure by total revenue for the previous month.

This prime measure requires access to internal information. As an example of cost of sales index 125, assume that last month MY Company incurred $2 million in selling expenses. Total revenue for the month was $10.42 million. Cost of Sales Index was (all $ in millions)

Cost of Sales Index=(2/10.42)=0.19

Adjusted monthly, this measure is an indication of the sales function's ability to turn prospects into customers cost effectively. The income statement account most affected by cost of sales index 125 is gross profit. The cost of sales index 125 is a leading indicator of the level of demand for the products and services offered by the organization.

The prime measures which may be affected by a change in the cost of sales index 125 include sales cycle index 122, sales close index 123, and sales price index 124.

Forecast Accuracy Index 126

Activities measured by the forecast accuracy index prime measure 126 are entirely contained within the scope of the sales effectiveness aggregate measure 120. The activities measured by forecast accuracy 126 involve the ability of the sales function to accurately predict demand for the products and services offered by the organization.

This prime measure requires that a formal sales forecasting process exists within the organization. The forecast accuracy 126 may be calculated as follows: Divide the total number of line items forecasted weekly that fall between +/−10% of actual weekly unit requirements by the total number of line items forecasted.

This prime measure requires access to internal information. As an example calculation of the forecast accuracy index 126, assume that last year MY Company implemented a sales forecasting system allowing the sales function to project demand at the stock keeping unit (SKU) level. Using the data available from this system, MY Company calculated the number of SKUs that were forecasted to within +/−10% of actual weekly demand to be 750. Total SKU's forecasted during the week were 1500 yielding:

Forecast Accuracy Index=(750/1500)=0.50

Adjusted weekly, this measure is an indication of the sales function's ability to accurately predict demand for the products and services offered by the organization. The income statement account most affected by forecast accuracy index 126 is operating expenses. The forecast accuracy index 126 is perhaps the single most important influence on operational efficiency.

The prime measures which may be affected by a change in the forecast accuracy 126 include on-time delivery 211, order fill rate 212, cash-to-cash cycle time 231, conversion cost 232, and asset utilization 233.

Customer Retention Index 127

Activities measured by the customer retention index prime measure 127 are entirely contained within the scope of the sales effectiveness aggregate measure 120. The activities measured by customer retention index 127 involve identifying and satisfying existing customer needs.

The customer retention index 127 may be calculated as follows: Identify the appropriate buying cycle for the industry the company competes in (baseline buying cycles may need to be established for each industry classification). Using the duration of this buying cycle, determine the number of existing customers that have not purchased products or services for this period of time. Divide this number by the total number of active customers and subtract the result from 1.

This prime measure requires access to internal information. As an example calculation of the customer retention index 127, assume that MY Company sells PC hardware components to corporate customers. The buying cycle for this industry is 6 months. By searching through the customer sales database, MY Company determined that 30 customers had not purchased any products for 6 months or longer. The total number of customers in MY Company's database is 75. MY Company marks inactive customers in the database every six months so that they are no longer considered active.

Customer Retention Index=1−(30/75)=0.60

Adjusted monthly, this measure is an indication of the organization's ability to satisfy existing customer needs. The income statement account most affected by customer retention index 127 is revenue. This prime measure is recognizes that it is cheaper to retain a customer then to acquire one.

The prime measures which may be affected by a change in the customer retention index 127 include market share index 113, sales cycle index 122, sales close index 123, sales price index 124, and cost of sales index 125.

New Products Index 131

Activities measured by the new products index prime measure 131 are entirely contained within the scope of the product development effectiveness aggregate measure 130. The activities measured by new products index 131 involve the emphasis placed by the organization on adapting its products and services to the changing demands of existing and potential customers.

The new products index 131 may be calculated as follows: Divide the revenue of the products and services released to the market during the past 12 months by the total revenue of the organization.

This prime measure requires access to internal information. As an example calculation of new products index 131, assume that during the past twelve months MY Company released 3 new product lines into the markets it serves. These products have generated $15 million in new revenue. MY Company's Total annual revenue for MY Company has been $125 million during the past twelve months yielding (all $ in millions):

New Products Index=(15/125)=0.12

Adjusted monthly, this measure is an indication of the emphasis placed by the organization on adapting its products and services to the changing demands of existing and potential customers. The income statement account most affected by new products index 121 is revenue. This prime an important indicator of business performance as research shows that a correlation exists between the revenue from new products and company stock price.

The prime measures which may be affected by a change in the new products index 1221 include target market index 111, market share index 113, opportunity/threat index 114, configurability index 117, product portfolio index 115, sales cycle index 122, and sales close index 123.

Feature Function Index 132

Activities measured by the feature function index prime measure 132 are entirely contained within the scope of the product development effectiveness aggregate measure 130. The activities measured by feature function index 132 involve the level and extent of the changes found in the new products and services offered by the organization.

This prime measure requires that a formal bill-of-material or bill-of-services system exists within the organization. For product companies, the feature function index 132 may be calculated as follows: Divide the number of new component items listed on the bill-of-material for products released to market during the past 12 months, by the total number of component items on the bill.

For service companies, the feature function index 132 may be calculated as follows: Divide the number of new skill sets required on the bill-of-services for new service offerings released to market during the past 12 months, by the total number of skill sets required on the bill.

This prime measure requires access to internal information. As an example calculation of the feature function index 132, assume that during the past twelve months MY Company released 3 new product lines into the markets it serves. MY Company uses an ERP system to plan production requirements. The number of new component items listed on the bills-of-material for the 3 new products released were 16. Total items listed on these bills were 145 yielding:

Feature Function Index=(16/145)=0.11

Adjusted monthly, this measure is an indication of the level and extent of the changes found in the new products and services offered by the organization. The income statement accounts most affected by feature function index 132 are revenue and operating expenses. New products can range from simple packaging changes or repositioned services with the same skilled resources all the way to completely different products and services offered to existing or new customers.

The prime measures which may be affected by a change in the feature function index 132 include target market index 111, market share index 113, opportunity/threat index 114, configurability index 117, product portfolio index 115, sales cycle index 122, sales close index 123, conversion cost 232, and asset utilization 233.

Time to Market Index 133

Activities measured by the time to market index prime measure 133 are entirely contained within the scope of the product development effectiveness aggregate measure 130. The activities measured by time to market index 133 involve the ability of the product development function to release new products and services on a timely basis.

The time to market index 133 may be calculated as follows: Determine the length of time measured in years between new product or service concept approval and market launch date. The calculation is performed on a twelve month rolling average basis.

This prime measure requires access to internal information. As an example calculation of time to market index 133, assume that during the past twelve months MY Company released 3 new product lines into the markets it serves. The number of years between concept approval and market launch date for each of these products were 2.1, 0.5 and 1.7 yielding:

Time To Market Index=(2.1+0.5+1.7)/3)=1.4 years

Adjusted monthly, this measure is an indication of the ability of the product development function to release new products and services on a timely basis. The income statement account most affected by time to market index 133 is revenue. The time to market index 133 is a useful measure, as research shows that a correlation exists between the revenue from new products and company stock price.

The prime measures which may be affected by a change in the time to market index 133 include market share index 113, configurability index 117, product portfolio index 115, sales cycle index 122, and sales close index 123.

Research and Development Success Index 134

Activities measured by the research and development success index prime measure 134 are entirely contained within the scope of the product development effectiveness aggregate measure 130. The activities measured by research and development success index 134 involve the ability of the product development function to bring new products and services to market.

This prime measure requires a formal product development tracking process to exist within the organization. Using such a tracking system, the research and development success index 134 may be calculated as follows: Determine the total number of successfully launched new products over the past 12 months divided by the total number of funded new product development projects budgeted to have been completed during the past 12 months (including those terminated prior to completion).

This prime measure requires access to internal information. As an example calculation of research and development success index 134, assume that MY Company has always managed its product development function using a formal project tracking system. During the past twelve months MY Company released 3 new product lines into the markets it serves, however these were among 10 approved concepts that were budgeted to be released during the same period. Fortunately the 7 failed projects were killed early in the development process.

R&D Success Index=(3/10)=0.30

Adjusted monthly, this measure is an indication of the ability of the product development function to bring new products and services to market. The income statement account most affected by research and development success index 134 is revenue. Research shows that a correlation exists between the revenue from new products and company stock price.

The prime measures which may be affected by a change in the research and development success index 134 include market share index 113, opportunity/threat index 114, configurability index 117, product portfolio index 115, sales cycle index 122, and sales close index 123.

On-Time Delivery 211

Activities measured by the on-time delivery prime measure 211 are entirely contained within the scope of the customer responsiveness aggregate measure 210. The activities measured by on-time delivery 211 involve the ability of the organization to meet customer expectations with respect to the time it takes to satisfy a specific order or service request. On-time delivery 211 is based on customer request date (not a negotiated date).

On-time delivery 211 may be calculated as follows: Total number of orders or requests for service delivered on time divided by the total number of orders or requests for service received. The calculation is performed on a 7 day rolling average basis.

This prime measure requires access to internal information. As an example calculation of on-time delivery 211, assume that during the past 7 days MY Company received 350 customer orders from the corporate accounts it services. Total number of orders received by the customers original request date was 330 yielding:

On-Time Delivery=(330/350)=0.94

Adjusted daily, this measure is an indication of the ability of the organization to meet customer expectations with respect to the time it takes to satisfy a specific order or service request. The income statement accounts most affected by on-time delivery 211 are revenue and operating expense. On-time delivery 211 applies to both product and services businesses. It is particularly important for organizations supplying corporate customers as these customers look to manage inventory levels by controlling the timing of material receipts.

The prime measures which may be affected by a change in on-time delivery 211 include market share index 113, configurability index 117, sales cycle index 122, sales close index 123, cash-to-cash cycle time 213, conversion cost 232, and asset utilization 233.

Order Fill Rate 212

Activities measured by the order fill rate prime measure 212 are entirely contained within the scope of the customer responsiveness aggregate measure 210. The activities measured by order fill rate 212 involve the ability of the organization to meet customer expectations with respect to the quantity of a specific order or service request. Meeting this expectation assumes that no orders were shipped over or under requested ship quantities.

The order fill rate 212 may be calculated as follows: Total number of orders filled correctly (shipment quantity equal customer request quantity) divided by total number of orders received. The calculation is performed on a 7 day rolling average basis.

This prime measure requires access to internal information. As an example calculation of order fill rate 212, assume that during the past 7 days MY Company received 350 customer orders from the corporate accounts it services. Total number of orders shipped with the correct quantity was 300 yielding:

Order Fill Rate=(300/350)=0.86

Adjusted daily, this measure is an indication of the ability of the organization to meet customer expectations with respect to the quantity requested by a specific customer order. The income statement accounts most affected by order fill rate 212 are revenue and operating expense. Order fill rate is particularly important for organizations supplying corporate customers as these customers look to manage inventory levels by controlling quantities received.

The prime measures which may be affected by a change in the order fill rate 212 include market share index 113, configurability index 117, sales cycle index 122, sales close index 123, cash-to-cash cycle time 231, conversion cost 232, and asset utilization 233.

Material Quality 213

Activities measured by the material quality prime measure 213 are entirely contained within the scope of the customer responsiveness aggregate measure 210. Material quality 213 measures the overall quality of the materials received by the customer and indicates whether the materials were either damaged or defective upon receipt. If either condition exists, the order is considered to have a material quality problem.

Material quality 213 may be calculated as follows: Total number of orders with material quality within agreed to tolerances and specifications divided by the total number of orders placed. The calculation is performed on a 7 day rolling average basis.

This prime measure requires access to internal information. As an example calculation of material quality 213, assume that during the past 7 days MY Company received 350 customer orders from the corporate accounts it services. Total number of orders received by those customers with material quality within specification was 345 yielding:

Material Quality=(345/350)=0.99

Adjusted daily, this measure is an indication of the ability of the organization to meet customer expectations with respect to the quantity requested by a specific customer order. The income statement accounts most affected by material quality 213 are revenue and operating expense. Global competition in the 1980's established very high expectations for product quality. Meeting expectations with regard to product specifications is now a requirement for doing business.

The prime measures which may be affected by a chance in the material quality 213 include market share index 113, configurability index 117, sales cycle index 122, sales close index 123, cash-to-cash cycle time 213, conversion cost 232, and asset utilization 233.

Service Accuracy 214

Activities measured by the service accuracy prime measure 214 are entirely contained within the scope of the customer responsiveness aggregate measure 210. Service accuracy 214 measures the overall availability and accuracy of the information necessary to complete the specific order or request for service. This information includes web-based order fulfillment and EDI information as well as shipment documentation.

Service accuracy 214 may be calculated as follows: Total number of orders or requests for service completed with available and accurate information divided by the total number of orders or requests for service processed. The calculation is performed on a 7 day rolling average basis.

This prime measure requires access to internal information. As an example calculation of service accuracy 214, assume that during the past 7 days MY Company received 350 customer orders from the corporate accounts it services. Total number of orders shipped with available and accurate information was 340 yielding:

Service Accuracy=(340/350)=0.97

Adjusted daily, this measure is an indication of the ability of the organization to meet customer expectations with respect to the information necessary to complete a specific customer order or request for service transaction. The income statement accounts most affected by service accuracy 214 are revenue and operating expense. Corporate as well as individual consumers demand available and accurate information to complete their purchasing transactions. This is becoming increasingly complex as sales coverage is broadened through use of the Internet.

The prime measures which may be affected by a change in the service accuracy 214 include market share index 113, configurability index 117, sales cycle index 122, sales close index 123, cash-to-cash cycle time 231, conversion cost 232, and asset utilization 233.

Service Performance 215

Activities measured by the service performance prime measure 215 are entirely contained within the scope of the customer responsiveness aggregate measure 210. The activities measured by service performance 215 involve the ability of the organization to complete customer requests within agreed to performance objectives. For continuous services, this metric indicates the percent of time (during expected hours of operation) that the service is available and usable by the customer. For discrete services, this metric indicates the percentage of incoming customer requests that are adequately responded to and completed. For the purpose of this metric, any time a customer request is not completed satisfactorily by the organization, the service is considered to have provided unacceptable performance. This could be because the customer could not initiate the request, or the customer's experience with the service was degraded by poor execution to the point of abandonment, payment rejection, or a service credit issued.

For continuous request services, the service performance 215 may be calculated as follows: The percent of time service is available to the customer during a set of standard expected hours of operation and performing adequately for the customer divided by total time service is expected to be available for customer.

For discrete request services, the service performance 215 may be calculated as follows: The number of customer requests that are adequately responded to and completed divided by total number of requests made by the customer during standard hours of operation.

The standard expected hours of operation are expected to be one of three categories:

Global business: 24 hours, 7 days a week

Regional business: 8 hours, 5 days a week

Extended business: 12 hours, 7 days a week

As an example, the service performance 215 for a web hosting service is the percent of time the web site is performing adequately and completing service requests (usually based on response time calculations, abandoned sessions statistics and site availability information).

For a package delivery service, service performance 215 is the percent of packages that were picked up and delivered based on customer request. If a request was made but the package was not picked up or picked up late, or delivered late or not delivered at all, the service did not perform for the customer.

Adjusted daily, this measure determines the ability of the organization to complete customer requests within agreed to performance objectives or within the customer's expectations of acceptable performance. Continuous as well as discrete services are covered by this performance measure. This measure takes into account both availability (ability to access the service) and performance (ability to use the service effectively).

The income statement accounts most affected by service performance 215 are revenue and operating expense. Service performance 215 is a base measure for all service provider business models. It indicates when a customer received a degraded experience from the service (and service provider), putting near term revenue and long term relationship at risk.

Prime measures which may be affected by a change in service performance 215 include agreement effectiveness 217 and transformation ratio 218.

Customer Care Performance 216

Activities measured by the customer care performance prime measure 216 are entirely contained within the scope of the customer responsiveness aggregate measure 210. Customer care performance 216 measures key aspects of customer service (problem resolution, questions and unplanned change requests) including time to respond and time to resolve. The activities measured by customer care performance 216 involve the ability of the customer care function to complete requests within the performance objectives. For the purpose of this metric, any time a customer care request is not completed satisfactorily by the organization, customer care is considered to have provided unacceptable performance. This could be because the customer could not initiate the request, or the customer's experience with the service falls outside tolerable performance criteria.

Customer care is expected to be available during standard hours of operation. Standard hours of operation are expected to be one of three categories:

Global business: 24 hours, 7 days a week

Regional business: 8 hours, 5 days a week

Extended business: 12 hours, 7 days a week

Customer care performance 216 may be calculated as follows: The number of customer care requests meeting response and resolution criteria divided by the total number of customer care requests during standard hours of operation.

Response and resolution criteria for customer care requests can vary by severity of the problem, and channel by which the request was submitted (phone, email, chat, self-service etc.). Each request is evaluated based on the severity and channel. As an example, assume that MY Company has the following criteria for email requests:

1 day response for URGENT email messages

2 days for others

7 day resolve for all email messages

Total email requests: 20 requests total, 3 URGENT

Actual Response and Resolution: 2 URGENT responded to in more than 1 day. 5 other messages responded to in more than 2 days. 4 unresolved within 7 days (1 of these also responded to late).

Based on the foregoing, the Customer Care Performance would be calculated as set forth below:

Customer Care Performance=(20−2 late URGENT responses−5 late other messages−3 unique late resolutions)/20=0.50

Adjusted daily, this measure determines the percent of requests for which the customer care organization is functioning at an adequate performance level. The income statement accounts most affected by customer care performance 216 are revenue and operating expense. Customer care performance 216 is a base measure for all customer care functions. It indicates when a customer received a degraded experience when requesting support or assistance for problems or unplanned changes, putting near term revenue and long term relationships at risk.

The prime measures which may be affected by a change in customer care performance 216 include agreement effectiveness 217, transformation ratio 218, and service performance 215.

Agreement Effectiveness 217

Activities measured by the agreement effectiveness prime measure 217 are entirely contained within the scope of the customer responsiveness aggregate measure 210. Agreement effectiveness 217 measures the overall effectiveness of the Service Level Agreements (SLAs) in place with all of the organization's service customers. In order to maintain positive working relationships with its customers, service providers must take a proactive role in assuring the service agreements in place are effective. Quarterly surveys to objectively determine the level of agreement effectiveness are recommended. The questions on these surveys must be grouped into to three separate categories. First, are the currently contracted services adequate for the customer's needs? Second, is the level of care adequate for the customer's needs? And third, is the level of transformation assistance adequate for the customer's needs? (See discussion of Transformation Ratio below).

The agreement effectiveness 217 may be calculated as follows: Total number of existing customers with 90% or better SLA satisfaction (that category of survey questions relating to SLAs, not performance or care) divided by the total number of existing customers.

This prime measure requires access to internal information. As an example calculation of agreement effectiveness 217, assume that MY Company provides IT out-sourcing services to corporate customers. MY Company surveys existing customers to determine the level of satisfaction with its service level agreements. Based on the most recent surveys, 10 customers scored 90% or better on those questions dealing with SLAs. MY Company has 20 corporate customers yielding:

Agreement Effectiveness=(10/20)=0.50

Adjusted monthly, this measure is an indication of the organization's ability to structure service level agreements that are “win-win” for the organization and its customers. The income statement accounts most affected by agreement effectiveness 217 are revenue and operating expense. Service level agreements have become the most significant factor for the success of a maturing out-sourcing relationship.

The prime measures which may be affected by a change in agreement effectiveness 217 include market share index 113, sales cycle index 122, sales close index 123, cash-to-cash cycle time 213, conversion cost 232, and asset utilization 233.

Transformation Ratio 218

Activities measured by the transformation ratio prime measure 218 are entirely contained within the scope of the customer responsiveness aggregate measure 210. The transformation ratio 218 measures the number of engagements or contracts where benefits are projected in terms of business value, and driven jointly by the organization and it's customers. The activity will be discerned by measuring the number of engagements or contracts the organization is involved in where:

a). Goals and benefits are projected in terms of business metrics;

b). A roles and responsibilities matrix exists that holds both the organization and the customer responsible for achieving the projected benefits; and optionally

c). May include a risk/reward metrics to enable sharing across the organization and the customer in the outcome of the initiative.

The transformation ratio 218 may be calculated as follows: Total number of existing contracts and engagements, and those planned for the next 12 months, where a) and b) above apply, divided by the total number of existing contracts and engagements.

This prime measure requires access to internal information. As an example calculation of transformation ratio 218, assume that MY Company provides IT out-sourcing services to corporate customers. MY Company jointly develops service level agreements with 10 of its customers. MY Company has 20 corporate customers yielding:

Transformation Ratio=(10/20)=0.50

Adjusted monthly, this measure is an indication of the organization's ability to structure service level agreements that are “win-win” for the organization and its customers. The income statement accounts most affected by transformation ratio 218 are revenue and operating expense. Service level agreements have become the most significant factor for the success of a maturing out-sourcing relationship.

Prime measures which may be affected by a change in the transformation ratio 218 include market share index 113, sales cycle index 122, sales close index 123, cash-to-cash cycle time 231, conversion cost 232, and asset utilization 233.

Supplier On-Time Delivery 221

Activities measured by the supplier on-time delivery prime measure 221 are entirely contained within the scope of the supplier effectiveness aggregate measure 220. The activities measured by supplier on-time delivery 221 involve the ability of the organization to select suppliers that can meet the organization's expectations with respect to the time it takes to satisfy a specific order or service request. Supplier on-time delivery 221 is based on the organization's request date (not a negotiated date).

Supplier on-time delivery 221 may be calculated as follows: Total number of orders or requests for service received on time divided by the total number of orders or requests for service received. The calculation is performed on a 7 day rolling average basis.

This prime measure requires access to internal information. As an example calculation of supplier on-time delivery 221, assume that during the past 7 days MY Company received 200 supplier shipments. Total number of orders received by MY Company's original request date was 150 yielding:

Supplier On-Time Delivery=(150/200)=0.75

Adjusted daily, this measure is an indication of the ability of the organization to select suppliers that can meet the organization's expectations with respect to the time it takes to satisfy a specific order or service request. The income statement account most affected by supplier on-time delivery 221 is operating expense. Supplier on-time delivery 221 applies to both product and services businesses. It is important as organizations look to manage inventory levels by controlling the timing of material receipts.

The prime measures which may be affected by a change in supplier on-time delivery 221 include time to market index 133, on-time delivery 211, order fill rate 212, cash-cycle time 231, conversion cost 232, and asset utilization 233.

Supplier Order Fill Rate 222

Activities measured by the supplier order fill rate prime measure 222 are entirely contained within the scope of the supplier effectiveness aggregate measure 220. The activities measured by supplier order fill rate 222 involve the ability of the organization to select suppliers that can meet the organizations expectations with respect to matching the quantity of specific orders or service requests. Meeting this expectation assumes that no orders were received over or under requested quantities.

Supplier order fill rate 222 may be calculated as follows: Total number of orders filled correctly (shipment quantity equal the requested quantity) divided by the total number of orders placed. This calculation is performed on a 7 day rolling average basis.

This prime measure requires access to internal information. As an example calculation of supplier order fill rate 222, assume that during the past 7 days MY Company received 200 supplier shipments. Total number of orders received with the correct quantity was 180 yielding:

Supplier Order Fill Rate=(180/200)=0.90

Adjusted daily, this measure is an indication of the ability of the organization to select suppliers that can meet the organizations expectations with respect to matching the quantity of specific orders or service requests. The income statement account most affected by supplier order fill rate 222 is operating expense. Supplier order fill rate 222 is particularly important for organizations supplying corporate suppliers as these suppliers look to manage inventory levels by controlling quantities received.

The prime measures which may be affected by a change in the suppler fill rate 222 include market share index 113, sales cycle index 122, sales close index 123, cash-to-cash cycle time 213, conversion cost 232, and asset utilization 233.

Supplier Material Quality 223

Activities measured by the supplier material quality prime measure 223 are entirely contained within the scope of the supplier effectiveness aggregate measure 220. Supplier material quality 223 measures the overall quality of the materials received from suppliers and indicates whether the materials were either damaged or defective upon receipt. If either condition exists, the supplier order is considered to have a material quality problem.

Supplier material quality 223 may be calculated as follows: Total number of supplier orders with material quality within agreed to tolerances and specifications divided by the total number of suppliers orders received. The calculation is performed on a 7 day rolling average basis.

This prime measure requires access to internal information. As an example calculation of supplier material quality 223, assume that during the past 7 days MY Company received 200 supplier shipments. Total supplier shipments with material quality within specification was 195 yielding:

Supplier Material Quality=(195/200)=0.98

Adjusted daily, this measure is an indication of the ability of the organization to select suppliers that can meet the organizations expectations with respect to agreed upon product specification. The income statement account most affected by supplier material quality 223 is operating expense. Supplier material quality 223 is an important prime measure, as the quality of the products and services offered by the organization can be no better then the quality of the materials received from suppliers.

The prime measures which may be affected by a change in supplier material quality 223 include market share index 113, sales cycle index 122, sales close index 123, cash-to-cash cycle time 231, conversion cost 232, and asset utilization 233.

Supplier Service Accuracy 224

Activities measured by the supplier service accuracy prime measure 224 are entirely contained within the scope of the supplier effectiveness aggregate measure 220. Suppler service accuracy 224 measures the overall availability and accuracy of the information necessary to obtain a specific supplier order or request for service. This information includes web-based order fulfillment and EDI information as well as shipment documentation.

Supplier service accuracy 224 may be calculated as follows: Total number of supplier orders or requests for service completed successfully with available and accurate information divided by the total number of supplier orders or requests for service processed. The calculation is performed on a 7 day rolling average basis.

This prime measure requires access to internal information. As an example calculation of supplier service accuracy 224, assume that during the past 7 days MY Company placed 200 supplier orders. Total number of supplier orders shipped with available and accurate information was 175 yielding:

Supplier Service Accuracy=(175/200)=0.88

Adjusted daily, this measure is an indication of the ability of the organization to select suppliers that can meet the organization's expectations with respect to the information necessary to complete a specific supplier order or request for service transaction. The income statement account most affected by supplier service accuracy 224 is operating expense. Organizations need to select suppliers that lower the overall cost of performing standard business transactions. Available and accurate supplier information lowers the total cost of doing business with a supplier.

The prime measures which may be affected by a change in supplier service accuracy 224 include market share index 113, sales cycle index 122, sales close index 123, cash-to-cash cycle time 231, conversion cost 232, and asset utilization 233.

Supplier Service Performance 225

Activities measured by the supplier service performance prime measure 225 are entirely contained within the scope of the supplier effectiveness aggregate measure 220. The activities measured by supplier service performance 225 involve the ability of the organization to select service providers that can complete requests within agreed to performance objectives. For continuous services, this metric indicates the percent of time (during expected hours of operation) that the service is available and usable by the organization. For discrete services, this metric indicates the percentage of outgoing requests that are adequately responded to and completed. For the purpose of this metric, any time a request for service is not completed satisfactorily by the provider, the service is considered to have provided unacceptable performance. This could be because the organization could not initiate the request, or the organization's experience with the service was degraded by poor execution to the point of abandonment, payment rejection, or a service credit issued.

For continuous request services, the supplier service performance 225 may be calculated as follows: The percent of time service is available to the organization during a set of standard expected hours of operation and performing adequately for the organization divided by total time service is expected to be available for organization.

For discrete request services the supplier service performance 225 may be calculated as follows: The number of requests that are adequately responded to and completed divided by total number of requests made by organization during standard hours of operation.

Standard expected hours of operation are expected to be one of three categories:

Global business: 24 hours, 7 days a week

Regional business: 8 hours, 5 days a week

Extended business: 12 hours, 7 days a week

As an example, assume that MY Company uses a web hosting service. For this service, supplier service performance 225 is the percent of time the web site is performing adequately and completing service requests (usually based on response time calculations, abandoned sessions statistics and site availability information).

MY Company also uses a package delivery service for business correspondence. For this service, supplier service performance is the percent of deliveries that were picked up and delivered according to the organization's request. If a request was made but the package was not picked up or picked up late, or delivered late or not delivered at all, the service did not perform for the organization.

Adjusted daily, this measure determines the ability of the organization to select service providers that can complete requests within agreed to performance objectives. Continuous as well as discrete services are covered by this performance measure. This measure takes into account both availability (ability to access the service) and performance (ability to use the service effectively).

The income statement accounts most affected by supplier service performance 225 are revenue and operating expense. Supplier service performance 225 is a base measure for all service provider business models. It indicates when an organization received a degraded experience from the service (and service provider), putting near term revenue and long term relationship at risk.

The prime measures which may be affected by a change in supplier service performance 225 include supplier care performance 226, supplier agreement effectiveness 227, and supplier transformation ratio 228.

Supplier Care Performance 226

Activities measured by the supplier care performance prime measure 226 are entirely contained within the scope of the supplier effectiveness aggregate measure 220. Supplier care performance 226 measures key aspects of a services provider's ability to perform customer service (problem resolution, questions and unplanned change requests) including time to respond and time to resolve. Activities measured by supplier care performance 226 involve the ability of the services provider's customer care function to complete requests within the performance objectives. For the purpose of this metric, any time a customer care request is not completed satisfactorily by the service provider, its customer care function is considered to have provided unacceptable performance. This could be because the organization could not initiate the request, or the organization's experience with the service falls outside tolerable performance criteria. Supplier care is expected to be available during standard hours of operation. Standard hours of operation are expected to be one of three categories:

Global business: 24 hours, 7 days a week

Regional business: 8 hours, 5 days a week

Extended business: 12 hours, 7 days a week

Supplier care performance 226 may be calculated as follows: The number of supplier care requests meeting response and resolution criteria divided by the total number of supplier care requests during standard hours of operation.

Response and resolution criteria for supplier care requests can vary by severity of the problem, and channel by which the request was submitted (phone, email, chat, self-service etc.). Each request is evaluated based on the severity and channel. As an example, assume that MY Company has the following criteria for email requests with a service provider:

1 day response for URGENT email messages

2 days for others

7 day resolve for all email messages

Total email requests: 20 requests total, 3 URGENT

Actual Response and Resolution: 2 URGENT responded to in more than 1 day; 5 other messages responded to in more than 2 days; and 4 unresolved within 7 days (one of these also responded to late).

The Supplier Care Performance 226 would be calculated as follows:

Supplier Care Performance=(20−2 late URGENT responses−5 late other messages−3 unique late resolutions)/20=0.50

Adjusted daily, this measure determines the percent of requests for which the supplier care organization is functioning at an adequate performance level. The income statement accounts most affected by supplier care performance 226 are revenue and operating expense. Supplier care performance 226 is a base measure for all supplier care functions. It indicates when a customer received a degraded experience when requesting support or assistance for problems or unplanned changes, putting near term revenue and long term relationships at risk.

The prime measures which may be affected by a change in supplier care performance 226 include supplier agreement effectiveness 227, supplier transformation ratio 228, and supplier service performance 225.

Supplier Agreement Effectiveness 227

Activities measured by the supplier agreement effectiveness prime measure 227 are entirely contained within the scope of the supplier effectiveness aggregate measure 220. Supplier agreement effectiveness 227 measures the overall effectiveness of the Service Level Agreements (SLAs) in place with all of the organization's service providers. In order to maintain positive working relationships with its providers, the organization must take a proactive role in assuring the service agreements in place are effective. Quarterly surveys to objectively determine the level of agreement effectiveness are recommended. The questions on these surveys must be grouped into three separate categories. First, are the currently contracted services adequate for the organization's needs? Second, is the level of care adequate for the organization's needs? And third, is the level of transformation assistance adequate for the organization's needs? (See Supplier Transformation Ratio)

Supplier agreement effectiveness 227 may be calculated as follows: Total number of existing service providers with a 90% or better SLA agreement effectiveness (that category of survey questions relating to SLAs not supplier performance or supplier care) divided by the total number of existing service providers.

This prime measure requires access to internal information. As an example calculation of supplier agreement effectiveness 227, assume that every 6 months, MY Company surveys existing SLA with each of its service providers to determine the level of satisfaction. Based on the most recent surveys, 3 service providers scored 90% or better on those questions dealing with SLAs. MY Company has a total of 5 service providers yielding:

Supplier Agreement Effectiveness=(3/5)=0.60

Adjusted monthly, this measure is an indication of the organization's ability to structure service level agreements that are “win-win” for the organization and its service providers. The income statement accounts most affected by supplier agreement effectiveness 227 are revenue and operating expense. As organizations continue to out-source non-critical business functions, service level agreements have become a critical success factor for the success of these provider relationships.

Prime measures which may be affected by a change in supplier agreement effectiveness 227 include market share index 113, sales cycle index 122, sales close index 123, cash-to-cash cycle time 231, conversion cost 232, and asset utilization 233.

Supplier Transformation Ratio 228

Activities measured by the supplier transformation ratio prime measure 228 are entirely contained within the scope of the supplier effectiveness aggregate measure 220. The supplier transformation ratio 228 measures the number of engagements or contracts where benefits are projected in terms of business value, and driven jointly by the organization and it's suppliers. The activity will be discerned by measuring the number of engagements or contracts the organization is involved in where:

a). Goals and benefits are projected in terms of business metrics;

b). A roles and responsibilities matrix exists that holds both the organization and the supplier responsible for achieving the projected benefits; and optionally

c). May include risk/reward metrics to enable sharing across the organization and the supplier in the outcome of the initiative.

The supplier transformation ratio 228 may be calculated as follows: Total number of existing contracts and engagements, and those planned for the next 12 months, where a) and b) above apply, divided by the total number of existing contracts and engagements.

This prime measure requires access to internal information. As an example calculation of supplier transformation ratio 228, assume that MY Company partners equally with 3 of its service providers in developing the service level agreement. MY Company has a total of 5 service providers yielding:

Supplier TransformationRatio=(3/5)=0.60

Adjusted monthly, this measure is an indication of the organization's ability to structure service level agreements that are “win-win” for the organization and its customers. The income statement accounts most affected by supplier transformation ratio 228 are revenue and operating expense. As organizations continue to out-source non-critical business functions, service level agreements have become a critical success factor for the success of these provider relationships.

The prime measures which may be affected by a change in the supplier transformation ratio 228 include market share index 113, sales cycle index 122, sales close index 123, cash-to-cash cycle time 231, conversion cost 232, and asset utilization 233.

Cash-to-Cash Cycle Time 231

Activities measured by the cash-to-cash cycle time prime measure 231 are entirely contained within the scope of the operational efficiency aggregate measure 230. Cash-to-cash cycle time 231 measures the length of time cash is used to fund the value added products and services provided by the organization.

Cash-to-Cash cycle time 231 may be calculated as follows: The sum of: Inventory days of supply+days sales outstanding−average payment period for materials.

This prime measure requires access to internal information. As an example calculation of Cash-to-Cash cycle time 231, assume that MY Company maintains an average of 30 days inventory (Inventory turns about 12 times per year), average days sales outstanding of 45 days, and pays its suppliers in 45 days on average yielding:

Cash-to-Cash Cycle Time=(30+45−45)=30 days

Adjusted daily, this measure is an indication of the organization's ability to manage cash efficiently through normal business operations. The income statement account most affected by cash-to-cash cycle time 231 is interest expense. One significant indicator of the market value of an organization is free cash flow. Managing cash is an indicator of the health of the business. Therefore, Cash-to-Cash cycle time 231 is an important indictor of business performance.

The prime measures which may be affected by a change in Cash-to-Cash cycle time 231 include supplier on-time delivery 221, supplier order fill rate 222, supplier material quality 223, supplier service accuracy 224, conversion cost 232, and asset utilization 233.

Conversion Cost 232

Activities measured by the conversion cost prime measure 232 are entirely contained within the scope of the operational efficiency aggregate measure 230. Conversion cost 232 measures the ability of the organization to manage procurement costs for all materials and services used to provide the products and services offered.

Conversion cost 232 may be calculated as follows: Sum the purchase cost of all materials and services (excluding payroll costs), divided by the revenue of the products and services they were used to produce. The calculation is performed on a monthly basis.

This prime measure requires access to internal information. As an example calculation of conversion cost 232, assume that for the past month MY Company earned revenue of $2.4 million. Using FIFO for inventory valuation, the procurement costs for this revenue was $1.8 million yielding (all $ in millions):

Conversion Costs=(1.8/2.4)=0.75

Adjusted monthly, this measure is an indication of the organization's ability to manage procurement costs for normal business operations efficiently. The income statement account most affected by conversion cost 232 is operating expense. Conversion cost 232 is an important indicator of business performance, as procurement costs are generally among the largest expenditures for most businesses.

The prime measures which may be affected by a change in conversion cost 232 include supplier on-time delivery 221, supplier order fill rate 222, supplier material quality 223, supplier service accuracy 224, and asset utilization 233.

Asset Utilization 233

Activities measured by the asset utilization prime measure 233 are entirely contained within the scope of the operational efficiency aggregate measure 230. Asset utilization 233 measures the ability of the organization to manage its assets effectively.

Asset utilization 233 may be calculated as follows: Total product and services revenue for the prior month (annualized) divided by total net assets. The calculation is performed on a monthly basis.

This prime measure requires access to internal information. As an example calculation of asset utilization 233, assume that for the past month MY Company earned revenue of $10.42 million ($125 million annualized). Looking at the net assets of the business, the total value was $50 million yielding (all $ in millions):

Asset Utilization=(125/50)=2.5

Adjusted monthly, this measure is an indication of the organization's ability to manage its assets carefully. The income statement account most affected by asset utilization 233 is operating expense. Return on net assets (RONA) is a key measure of business performance that is used by financial analysts. Asset Utilization is a “snap-shot” view of RONA.

The prime measures which may be affected by a change in asset utilization 233 include on-time delivery 211, order fill rate 212, material quality 213, service accuracy 214, Cash-to-Cash cycle time 231, and conversion cost 232.

Sigma Value 234

Activities measured by the sigma value prime measure 234 are entirely contained within the scope of the operational efficiency aggregate measure 230. The calculation of sigma value 234 begins with identifying the Critical-To-Quality (CTQ) characteristics found in the product or service provided by the organization. The CTQs are those characteristics deemed important enough to determine whether a product or service is accepted or rejected. A parameter “M” is defined as the total number of CTQs for a given product/service specification. This number remains static from one batch to the next. This information is generally available from the organization's quality control (QC) program, but can be built for those processes not covered by QC. Next, the calculation uses a concept called Defects Per Unit (DPU). DPU is the total number of failed CTQs found in a number of observed units, divided by the number of units observed. The final two concepts are Defects Per Opportunity (DPO) and Defects Per Million Opportunities (DPMO). DPO is DPU/M. Defects Per Million Opportunities (DPMO) is simply DPO multiplied by 1,000,000. Once DPMO is known, the sigma value can be found in the Six Sigma table (see, e.g., Mikel Harry & Richard Schroeder, Six Sigma—The Breakthrough Management Strategy).

The sigma value can be calculated as follows: Sigma value (from table)=DPMO

Where:

DPMO=Defects Per Million=DPO×1,000,000.

DPO=Defects Per Opportunity=DPU/M

DPU=Defects Per Unit=number of failed CTQs divided by number of Units

M=Total possible CTQs

CTQ=Critical to quality=Inspection criterion

U=Number of Units Produced from Process Step

As an example calculation of sigma value 234, assume that MY Company produces many PC hardware products. One of these, Product A, has 10 specifications. All of these specifications must be within tolerance for a unit to pass inspection. My Company inspects units produced by lot number. There can be anywhere from 100-200 units in a lot. Lot # 123 contained 150 units of Product A. The inspection revealed 50 defects in 10 units (5 failed specifications per unit) yielding:

DPU=50/150=0.33

DPO=0.33/10=0.033

DPMO=0.033×1,000,000=33,333.

Sigma Value=3.35

Adjusted daily, this measure is an indication of the organization's ability to manage critical processes in normal business operations. The income statement account most affected by sigma value 234 is operating expense. Most companies in the U.S. perform their most critical operations at a 3.5 to 4.0 sigma level (Mikel Harry & Richard Schroeder, Six Sigma—The Breakthrough Management Strategy). Mikel Harry and Richard Schroeder have determined that at this level of performance most U.S. companies cost-of-quality is between 25-30% of revenue. At six sigma, the cost-of-quality drops to less than 1% of revenue.

The prime measures which may be affected by a change in the sigma value 234 include on-time delivery 211, order fill rate 212, material quality 213, service accuracy 214, supplier on-time delivery 221, supplier order fill rate 222, supplier material quality 223, supplier service accuracy 224, Cash-to-Cash cycle time 231, conversion cost 232, and asset utilization 233.

Recruitment Effectiveness Index 311

Activities measured by the recruitment effectiveness index prime measure 311 are entirely contained within the scope of the human resources responsiveness aggregate measure 310. The activities measured by recruitment effectiveness index 311 involve the ability of the organization to obtain qualified candidates for open positions effectively. This measure includes the time and cost to recruit candidates for open positions.

The recruitment effectiveness index 311 may be calculated as follows: Average relative recruitment time multiplied by relative recruitment cost for each employee hired during the past 12 months. Relative recruitment time is calculated by subtracting from 1 the length of time (measured in days) between recruitment approval and hire date divided by 365. Relative recruitment cost is calculated by subtracting from 1 the total recruitment costs divided by committed first year compensation.

This prime measure requires access to internal information. As an example calculation of recruitment effectiveness 311, assume that during the past 12 months, MY Company hired 260 employees. The average length of time spent to recruit these employees was 90 days. The average recruiting costs (measured as a percent of first year compensation was 20%) yielding:

Recruitment Effectiveness=[1−(90/365)]×(1−0.20)=0.60

Adjusted monthly, this measure is an indication of the organization's ability to qualified candidates for open positions effectively. The income statement accounts most affected by recruitment effectiveness 311 are revenue and operating expenses. Recruitment costs are a significant cost in most organizations.

The prime measures which may be affected by a change in the recruitment effectiveness index 311 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, Cash-to-Cash cycle time 231, conversion cost 232, and asset utilization 233.

Benefits Administration Index 312

Activities measured by the benefits administration index prime measure 312 are entirely contained within the scope of the human resources responsiveness aggregate measure 310. Activities measured by benefits administration index 312 involve the ability of the organization to provide employee benefits cost effectively.

The benefits administration index 312 may be calculated as follows: Calculate the total health benefits costs for the past twelve months. Divide the result by total employee compensation for the past twelve months.

This prime measure requires access to internal information. As an example calculation of the benefits administration index 312, assume that during the past 12 months MY Company paid $16.8 million in health benefit costs. Total employee compensation for the past 12 months was $60 million yielding (all $ in millions):

Benefits Administration Index=(16.8/60)=0.28

Adjusted weekly, this measure is an indication of the organization's ability to provide health benefits cost effectively. The income statement account most affected by benefits administration index 312 is operating expenses. The benefits administration index 312 is an indication of the organization's ability to manage health benefits costs.

The prime measures which may be affected by a change in the benefits administration index 312 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, Cash-to-Cash cycle time 231, conversion cost 232, and asset utilization 233.

Skills Inventory Index 313

Activities measured by the skills inventory index prime measure 313 are entirely contained within the scope of the human resources responsiveness aggregate measure 310. The activities measured by skills inventory index 313 involve the ability of the organization to meet the skills required of its employees to complete all of its business activities. Out-sourced business activities are not considered part of these skill requirements.

This prime measure requires that a formal skills inventory process exist within the organization. The skills inventory index 313 may be calculated as follows: Using the skill requirements of the job functions performed by employees, divide the total number of skills filled by existing employees by the total number of skills required.

This prime measure requires access to internal information. As an example calculation of the skills inventory index 313, assume that last year MY Company began offering service contracts to its customers. Providing this service required that its employees needed many new skills. Based on the skills inventory system in MY Company's HR system, the number of new skills added to the inventory was 10. Although MY Company's current employees filled all the previous skill requirements, none had any of the new skills required. The total number of active skills in the system after adding the new skills was 25 yielding:

Skills Inventory Index=(15/25)=0.60

Adjusted weekly, this measure is an indication of the organization's ability to accurately meet the demands for its products and services. The income statement accounts most affected by skills inventory index 313 are revenue and operating expenses. The skills inventory index 313 is an indication of the organizations ability to move quickly into new lines of business. It is also a factor in the decision to out-source.

The prime measures which may be affected by a change in the skills inventory index 313 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, Cash-to-Cash cycle time 231, conversion cost 232, and asset utilization 233.

Employee Training Index 314

Activities measured by the employee training index prime measure 314 are entirely contained within the scope of the human resources responsiveness aggregate measure 310. The activities measured by employee training index 314 involve the commitment of the organization to invest in its employees as the changing demands of its customers require new knowledge and skills.

The employee training index 314 may be calculated as follows: Divide the total number of 8-hour working days each employee has spent in company-sponsored training during the previous 12 months by 225 times the number of full time equivalent positions.

This prime measure requires access to internal information. As an example calculation of employee training index 314, assume that during the past 12 months the employees of MY Company spent 10,000, 8-hour working days in company sponsored training. There are currently 2000 FTE positions at MY Company yielding:

Employee Training Index=(10,000/(2000*225))=0.0222

Adjusted weekly, this measure is an indication of the organization's commitment to invest in its employees. The income statement accounts most affected by employee training index 314 are revenue and operating expenses. Knowledge management and the management of intangible assets have become increasing significant factors in determining real business value. Attracting and holding superior talent requires evidence of commitment on the part of the organization to invest in its employees.

The prime measures which may be affected by a change in the employee training index 314 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, cash-to-cash cycle time 231, conversion cost 232, asset utilization 233, and recruitment effectiveness 311.

HR Advisory Index 315

Activities measured by the human resources (HR) advisory index prime measure 315 are entirely contained within the scope of the human resources responsiveness aggregate measure 310. The HR advisory index 315 measures the amount of activity the HR function is involved in with strategic business initiatives. This activity will be discerned by measuring the number of projects and initiatives the HR function is involved with where:

a). Goals and benefits are projected in terms of business metrics;

b). A roles and responsibilities matrix exists that holds both HR and business functions responsible for achieving the projected benefits; and optionally

c). Risk/reward metrics to enable sharing with HR the outcome of the initiative.

The HR advisory index 315 may be calculated as follows: Total number of existing HR projects, and projects planned for the next 12 months where a) and b) above apply divided by the total number of planned strategic initiatives at the corporate level.

This prime measure requires access to internal information. As an example of HR advisory index 315, assume that during the past 12 months, MY Company sought the advice of its HR function in 3 of its strategic business initiatives (both acquisitions). HR dedicated 2 FTE to complete each of these projects. In all, My Company completed 5 corporate initiatives yielding:

HR Advisory Index=3/5=0.60

Adjusted quarterly, this measure is an indication of HR's role as an advisor to the business. The income statement account most affected by HR advisory index 315 is operating expense. HR possess a unique understanding of the business and it capabilities. Choosing to leverage this knowledge, rather then seek outside advice, adds value to the business.

The prime measures which may be affected by a change in the HR advisory index 315 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, cash-to-cash cycle time 231, conversion cost 232, and asset utilization 233.

HR Total Cost Index 316

Activities measured by the HR total cost index prime measure 316 are entirely contained within the scope of the human resources responsiveness aggregate measure 310. The HR total cost index 316 measures the overall cost to provide HR support and advisory services to the organization.

The HR total cost index 316 may be calculated as follows: Determine the total cost (labor & expenses, not real estate) of providing HR support and advisory services as a percent of revenue.

This prime measure requires access to internal information. As an example calculation of the HR total cost index 316, assume that during the past 12 months, MY Company spent $2.1 million on HR Support and advisory services. Total Revenue for My Company during this period was $125 million yielding (all $ in millions):

HR Total Cost Index=2.1/125=0.017

Updated quarterly, HR total cost index measures the cost of providing HR support and advice to the organization. The income statement account most affected by HR total cost index 316 is operating cost. Identifying the existing HR total cost index establishes the foundation for evaluating business process outsourcing alternatives. These alternatives must be viewed against the quality of services provided internally.

The prime measures which may be affected by a change in the HR total cost index 316 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, cash-to-cash cycle time 231, conversion cost 232, and asset utilization 233.

Systems Performance 321

Activities measured by the systems performance prime measure 321 are entirely contained within the scope of the IT Responsiveness aggregate measure 320. The activities measured by systems performance 321 involve the percentage of time the applications, systems and infrastructure supported by the IT organization (and its service providers) are performing within their performance objectives. This metric indicates the amount of time during expected hours of operation that all services are available and usable by the organization. For the purpose of this metric, any time outages, poor response time, degraded throughput, or other performance-related breaches of expected service levels occurs and affects the users of the organization ability to perform, the service is considered to have provided unacceptable performance.

Systems performance 321 may be calculated as follows: The amount of time all systems are available to the organization during a set of standard expected hours of operation and performing adequately for the user divided by total time systems are expected to be available. Standard expected hours of operation are expected to be one of three categories:

Global business: 24 hours, 7 days a week

Regional business: 8 hours, 5 days a week

Extended business: 12 hours, 7 days a week

As an example of a systems performance calculation in a 24 hour-seven day a week IT environment, assume that over a month the following separate incidents occurs:

There is a network outage of 1 hour;

Sluggish (beyond agreed upon threshold for application response time) response to the customer inquiry application occurs for 4 hours; and

The external web site is unreachable for 2 hours.

Systems Performance calculation for the month=(720 hours total hours of expected service−7 hours of distinct outage or performance problems)/720 total hours of expected service=99.0%

Adjusted daily, systems performance gives an overall indication of the reliability of the service provided to the organization by the IT organizations (and its service providers). The income statement account most affected by systems performance 321 is operating expense. Systems performance 321 measures the total time all supported IT systems, applications and infrastructure are available and functioning at appropriate levels, usually defined in an internal service level agreement or memorandum of understanding between the IT organization and the users within the business units. It is not appropriate to manage specific system components or to indicate trouble in a particular area, where more system management tools are required, and assumed to be in place.

The prime measures which may be affected by a change in systems performance 321 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, cash-to-cash cycle time 231, conversion cost 232, and asset utilization 233.

IT Support Performance 322

Activities measured by the IT support performance prime measure 322 are entirely contained within the scope of the IT Responsiveness aggregate measure 320. IT support performance 322 measures the ability of IT support functions to provide organization users with support for problem resolution, questions and unplanned change requests. The measure accounts for the availability of support (time to respond), and performance of the support function (time to resolve). Activities measured by IT Support Performance 322 involve the percentage of requests completed within the performance objectives, as required by an SLA or other determining threshold. For the purpose of this metric, any time a support request is not completed satisfactorily by the support function, then support performance is considered to have provided unacceptable performance to the user. This could be because the user could not initiate the request, or the user's experience with the support service falls outside tolerable performance criteria.

IT support is expected to be available during standard hours of operation. Standard expected hours of operation are expected to be one of three categories:

Global business: 24 hours, 7 days a week

Regional business: 8 hours, 5 days a week

Extended business: 12 hours, 7 days a week

IT support performance 322 may be calculated as follows: The number of IT support requests meeting response and resolution criteria divided by the total number of IT support requests during standard hours of operation.

Response and resolution criteria for IT support requests can vary by severity of the problem, and channel by which the request was submitted (phone, email, chat, self-service etc.). Each request is determined to have met or not met response and resolution criteria appropriate for the severity and channel. As an example of an IT support performance calculation, assume MY Company has the following profile of phone IT support requests:

Phone example for a day:

Criteria:

Answer within 3 rings

7 day resolve for all support requests

Example requests:

112 requests total

Response and resolution:

100 answered within 3 rings,

1 abandoned after more than 3 rings,

11 in voicemail (more than three rings, and left message)

108 resolved within 7 days, 3 late (two were in voicemail)

The IT Support Performance metric would be calculated as follows: IT Support Performance=(112−1 abandoned−11 in voicemail−1 unique late resolutions)/112=99/112=88%

Updated daily, this measure determines the percentage of requests for which the IT Support organization is meeting its performance levels. The income statement account most affected by it support performance 322 is operating expense. IT Support Performance 322 is a base measure for all IT support functions. It indicates when a user received a degraded experience when requesting support or assistance for problems or unplanned changes, affecting their ability to complete assigned work.

The prime measures which may be affected by a change in IT support performance 322 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, cash-to-cash cycle time 231, conversion cost 232, and asset utilization 233.

Partnership Ratio 323

Activities measured by the partnership ratio prime measure 323 are entirely contained within the scope of the IT responsiveness aggregate measure 320. The partnership ratio 323 measures the amount of activity occurring on IT-based business initiatives where benefits are projected in terms of business value, and driven from inside and outside the IT functions. The activity will be discerned by measuring the number of projects and initiatives the IT functions are involved with where:

a). Goals and benefits are projected in terms of business metrics;

b). A roles and responsibilities matrix exists that holds both IT and business functions responsible for achieving the projected benefits; and optionally

c). May include risk/reward metrics to enable sharing across IT and business in the outcome of the initiative.

The partnership ratio 323 may be calculated as follows: Total number of existing IT projects, and projects planned for the next 12 months where a) and b) above apply, divided by the total number of planned IT initiatives.

As an example calculation of a partnership ratio calculation, assume that the IT department of XYZ Company has three ongoing projects, as follows:

Project 1: Sales force automation, where software will be introduced to make sales people more productive. Sales and IT evaluated software and methodology together. IT business case projected productivity increases resulting in additional revenue through use of the software. Sales awaited implementation. No one in Sales was charged with responsibility to ensure the people or processes were optimized to exploit the software.

Project 2: Server consolidation: IT plans to upgrade server hardware, which will enable them to consolidate 9 physical systems onto 5.

Project 3: Redesign of the company's web site and external web infrastructure: IT and Marketing decide jointly on goals for increasing web audience, and time spent on the web site (the two key metrics for the project). IT takes responsibility for ensuring site availability, acceptable response time, and to provide design guidelines to marketing to maximize site performance. Marketing takes responsibility for ensuring freshness and relevancy of the date, driving new requirements for the site, and activities to generate visits.

Partnership ratio calculation: Only Project 3 has the possibility to qualify as a partnership project. Project 1 should be, but isn't because there was no shared responsibility. Project 2 is a great project for TCO savings, but is not a partnership candidate as the benefits are “invisible” to the business users.

Partnership Ratio=1/3=0.33

Adjusted monthly, this measure is an indication of the organization's ability to integrate its business operations with its IT function to maximize the effectiveness of overall solutions. The income statement accounts most affected by partnership ratio 323 are revenue and operating expense. Value-based projects often have grand intentions, but end up not delivering due to confusion on roles and responsibilities and accountability for delivering the projected value. Partnership ratio 323 gives a broad measure of how many effective touch points exist between IT and the business.

The prime measures which may be affected by a change in the partnership ratio 323 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, cash-to-cash cycle time 231, conversion cost 232, and asset utilization 233.

Service Level Effectiveness 324

Activities measured by the service level effectiveness prime measure 324 are entirely contained within the scope of the IT responsiveness aggregate measure 320. Service level effectiveness 324 measures the overall effectiveness of the expected service levels in place with all of the users of IT. In order to maintain positive working relationships with its users, IT service providers must take a proactive role in assuring the service levels being delivered are effective. Quarterly surveys to objectively determine service level effectiveness are recommended. The questions on these surveys must be grouped into to three separate categories. First, does the level of expected service meet the organization's needs? Second, does the level of expected IT Support meet the organization's needs? Third, does the level of partnership between IT and the business units meet the organization's needs? Service level effectiveness 324 may be calculated as follows: Total number of surveyed users with 90% or better service level effectiveness divided by the total number of surveyed users.

This prime measure requires access to internal information. As an example calculation of service level effectiveness 324, assume that MY Company's internal IT group provides IT services to internal users. MY Company surveys internal users to determine the level of effectiveness of its expected service levels. Based on the most recent surveys, 110 users scored 90% or better. MY Company has 200 internal users yielding:

Service Level Effectiveness=(110/200)=0.55

Adjusted quarterly, this measure is an indication of the organization's ability to structure service level expectations that are “win-win” for the organization and its IT providers. The income statement accounts most affected by service level effectiveness 324 are revenue and operating expense. Service level effectiveness 324 has become a significant factor for the success of a maturing support services relationship.

The prime measures which may be affected by a change in the service level effectiveness 324 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, cash-cash cycle time 231, conversion cost 232, and asset utilization 233.

New Projects Index 325

Activities measured by the new projects index prime measure 325 are entirely contained within the scope of the IT responsiveness aggregate measure 320. The new projects index 325 measures the ability of the IT function to deliver new projects into the organization within cost, time and value objectives.

The new projects index 325 may be calculated as follows: Total projects that were undertaken within the last 12 months and all currently underway that operated or are operating on or below budget, at or ahead of schedule, and delivering at least the business value expected from the initial business case divided by total number of projects undertaken in the last twelve months or are currently underway.

As an example of new project index calculation, assume MY Company's current IT project portfolio has the following characteristics:

PROJECT 1: On time, on budget, value in line with expectations

PROJECT 2: Late, over budget, under-delivering on projected value

PROJECT 3: On time, on budget, under-delivering on projected value

PROJECT 4: On time, over budget, over delivering on projected value

New Projects Index=(1/4)=0.25

Updated quarterly, new projects index measures an IT function's ability to forecast its behavior on new projects. It acts as an accuracy indicator for time, cost and value projections, and as a confidence indicator on the IT function's ability to execute on a given project plan. The income statement account most affected by new projects index 325 is operating cost. New projects account for a large portion of IT investment by an organization. This index is a leading indicator to whether the value will be generated according to plan, and whether the IT function is capable of future project work similar to what has been attempted in the past.

The prime measures which may be affected by a change in the new projects index 325 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, cash-to-cash cycle time 231, conversion cost 232, and asset utilization 233.

IT Total Cost index 326

Activities measured by the IT total cost index prime measure 326 are entirely contained within the scope of the IT responsiveness aggregate measure 320. The IT total cost index 326 measures the overall Total Cost of Ownership (TCO) for technology owned, operated or supported by the organization.

The IT total cost index 326 may be calculated as follows: IT Total Cost Index is developed from the sum of all major budgeted and unbudgeted technology-related costs in the categories below divided by Total Revenue of the Organization.

Direct costs may include: hardware and software; management; support; applications development and integration; and communications fees. Indirect (i.e., unbudgeted) costs may include: end-user IS—the cost of end users supporting themselves (and each other) instead of relying on formal IS support channels; and downtime—the lost productivity due to planned (i.e., scheduled) and unplanned unavailability

As an example of IT total cost index 326, assume that MY Company's IT total cost items are:

IT Budget: $2.75 million

Estimated Indirect Costs: $1 million

My Company's Annual Revenue: $125 million

Therefore, the IT total cost index for MY Company may be calculated as follows:

IT Cost Index=(2.75+1)/125=0.03

Updated quarterly, IT total cost index measures an IT function's efficiency within all cost categories. The income statement account most affected by IT total cost index 326 is operating cost. As IT spending becomes a larger and larger portion of overall organization spending, it becomes important to track a IT total cost index over time and benchmark it to similar organizations to ensure money continues to be spent wisely.

The prime measures which may be affected by a change in IT total cost index 326 include sales cycle index 122, sales close index 123, forecast accuracy index 126, time-to-market index 133, research and development success index 134, on-time delivery 211, order fill rate 212, material quality 213, service accuracy 214, supplier on-time delivery 221, supplier order fill rate 222, supplier material quality 223, supplier service accuracy 224, cash-to-cash cycle time 231, conversion cost 232, and asset utilization 233.

Compliance Index 331

Activities measured by the compliance index prime measure 331 are entirely contained within the scope of the finance and regulatory responsiveness aggregate measure 330. The activities measured by compliance index 331 involve the ability of the finance and regulatory functions to comply with all applicable laws and regulations with regard to filings and transactions necessary for normal business operations.

The compliance index 331 may be calculated as follows: Calendar by month the number of legal and regulatory filings and transactions necessary to conduct normal business operations. Subtract from 1 the number of extensions, late, missed or incorrect filings and transactions for the past 12 months divided by the total for the same period.

This prime measure requires access to internal information. As an example calculation of the compliance index 331, assume that during the past 12 months, MY Company determined that there were 250 legal and regulatory filings and transactions necessary to conduct normal business operations. All but 20 were completed as required yielding:

Compliance Index=1−(20/250)=0.92

Adjusted monthly, this measure is an indication of the organization's ability to comply with all applicable laws and regulations with regard to filings and transactions necessary for normal business operations. The income statement account most affected by compliance index 331 is operating expenses. Identifying the necessary legal and regulatory filings and transactions establishes the foundation for evaluating business process outsourcing alternatives.

The prime measures which may be affected by a change in the compliance index 331 include time-to-market index 133, cash-to-cash cycle time 231, conversion cost 232, and asset utilization 233.

Accuracy Index 332

Activities measured by the accuracy index prime measure 332 are entirely contained within the scope of the finance and regulatory responsiveness aggregate measure 330. The activities measured by accuracy index 332 involve the ability of the finance and regulatory functions to provide accurate and timely information internally.

The accuracy index 332 may be calculated as follows: Calendar by month the number of documents and reports (both reoccurring and ad-hoc) requested form all internal business operations. Subtract from 1 the number declined requests, missed deadlines or adjustments necessary following delivery of the document or report divided by the total requested.

This prime measure requires access to internal information. As an example calculation of the accuracy index 332, assume that during the past 12 months, MY Company determined that there were 400 internal requests (both reoccurring and ad-hoc) for information from its Finance and Regulatory Functions. All but 50 were completed as required yielding:

Accuracy Index=1−(50/400)=0.87

Adjusted monthly, this measure is an indication of the finance and regulatory functions ability to provide accurate and timely information internally. The income statement account most affected by accuracy index 332 is operating expenses. Identifying the necessary internal information requests establishes the foundation for evaluating business process outsourcing alternatives.

The prime measures which may be affected by a change in the accuracy index 332 include cash-to-cash cycle time 231, conversion cost 232, and asset utilization 233.

Advisory Index 333

Activities measured by the advisory index prime measure 333 are entirely contained within the scope of the finance and regulatory responsiveness aggregate measure 330. The advisory index 333 measures the amount finance and/or regulatory are involved with strategic business initiatives. This activity will be discerned by measuring the number of projects and initiatives the finance and/or regulatory functions are involved with where:

a). Goals and benefits are projected in terms of business metrics;

b). A roles and responsibilities matrix exists that holds both finance and regulatory and business functions responsible for achieving the projected benefits; and optionally

c). Risk/reward metrics to enable sharing with finance and/or regulatory the outcome of the initiative.

The advisory index 333 may be calculated as follows: Total number of existing finance and/or regulatory projects, and projects planned for the next 12 months where a) and b) above apply, divided by the total number of planned strategic initiatives at the corporate level.

This prime measure requires access to internal information. As an example calculation of the advisory index 333, assume that during the past 12 months, MY Company sought the advice of its finance function in 2 of its strategic business initiatives (both acquisitions). The finance dedicated 4 FTE to complete each of these projects. In all, My Company completed 5 corporate initiatives yielding:

Advisory Index=2/5=0.40

Adjusted quarterly, this measure is an indication of finance's and/or regulatory's role as an advisor to the business. Income statement account most affected by advisory index 333 is operating expense. Finance and regulatory possess a unique understanding of the business and its capabilities. Choosing to leverage this knowledge, rather then seek outside advice, adds value to the business.

The prime measures which may be affected by a change in the advisory index 333 include time-to-market index 133, conversion cost 232, and asset utilization 233.

Cost of Service Index 334

Activities measured by the cost of service index prime measure 334 are entirely contained within the scope of the finance and regulatory responsiveness aggregate measure 330. The cost of service index 334 measures the overall cost to provide finance and regulatory support and advisory services to the organization.

The cost of service index 334 may be calculated as follows: Determine the total cost (labor and expenses, not real estate) of providing finance and regulatory support and advisory services as a percent of revenue.

This prime measure requires access to internal information. As an example calculation of the cost of service index 334, assume that during the past 12 months, MY Company spent $3.13 million on finance and regulatory support and advisory services. Total Revenue for My Company during this period was $125 million yielding (all $ in millions):

Cost of Service Index=3.13/125=0.025

Updated quarterly, the cost of service index 334 measures the cost of providing finance and regulatory support and advice to the organization. The income statement account most affected by cost of service index 334 is operating cost. Identifying the existing cost of service establishes the foundation for evaluating business process outsourcing alternatives. These alternatives must be viewed against the quality of services provided internally.

The prime measures which may be affected by the cost of service index 334 include conversion cost 232 and asset utilization 233.

Most of the prime measures provided herein are expressed in percentage form as an index and move in the same direction (e.g., an increase in percentage denotes an improvement). However, this is not always the case (i.e. sales cycle index 122, time to market index 133, and cash-to-cash cycle time 231 are measured in days). Given that the aggregate measures are calculated by multiplying the selected primes, all primes should be expressed in percentage form and should move in the same direction.

Therefore, a conversion routine may be used to convert a non-index based prime measure into an index-based prime measure. The conversion routine involves subtracting from 1 a quotient provided by a value of the non-index based prime measure divided by an upper bound of the non-index based prime measure.

The sales cycle index 122 is expressed by a number of days. The upper bound of the sales cycle index 122 is (approximately) 365 days. Therefore, to convert the sales cycle index 122 into percentage form, the sales cycle index is divided by 365 (or 366 in a leap year), and that result is subtracted from 1.

The time to market index 133 expressed by a number of days. The upper bound is (approximately) 730 days (2 years). Therefore, the time to market index 133 may be converted into a percent by dividing it by 730 and subtracting that result from 1.

The cash-to-cash cycle time 231 is expressed by a number of days. The upper bound for the cash-to-cash cycle time 231 is approximately 180 days. Therefore, to convert cash-to-cash cycle time 231 to a percentage, it is divided by 180, and that result is subtracted from 1.

The present invention may be used for many useful management purposes and can support many different types of business tools and applications. In an example embodiment of the invention, at least one of the prime measures may be applied to at least one of return on investment analysis, linking vision to action, IT to business alignment, external reporting, strategic alliances, due diligence, incentive compensation plans, business activity monitoring, monitoring service level agreements, and supplier ratings.

The present invention may also be used to support a strategic planning method of the business using at least one of the prime measures. For example, the strategic planning method may comprise the well-known balanced scorecard method.

It should now be appreciated that the present invention provides advantageous methods and apparatus for evaluating business performance which are applicable to a wide variety of business.

Although the invention has been described in connection with various illustrated embodiments, numerous modifications and adaptations may be made thereto without departing from the spirit and scope of the invention as set forth in the claims.

What is claimed is:

1. A method for evaluation of business performance, comprising:
dividing actionable activities of a business into a plurality of business aspects;
establishing a plurality of aggregate measures for each business aspect, each of said aggregate measures comprising a set of related actionable activities for a respective business aspect;
establishing a plurality of prime measures for each aggregate measure, each of said prime measures quantifying one or more actionable activities from said set of related actionable activities; and
calculating a value of at least one of said prime measures to provide an indication of said business performance.

2. A method in accordance with claim 1, further comprising:
calculating values of each of said prime measures for at least one of said aggregate measures; and
calculating a value of at least one aggregate measure by multiplying said values of each of the prime measures for that aggregate measure together to provide an indication of business performance.

3. A method in accordance with claim 1, further comprising:
calculating values of each of said prime measures for each of said aggregate measures; and
calculating a value of each aggregate measure by multiplying said values of each of the prime measures for that aggregate measure together to provide an indication of overall business performance.

4. A method in accordance with claim 1, wherein:
each prime measure provides a basis to determine an impact of a business project or process on overall business performance.

5. A method in accordance with claim 1, wherein:
said aggregate measures and said prime measures collectively comprise leading indicators of financial performance.

6. A method in accordance with claim 1, wherein:
the plurality of prime measures is collectively exhaustive of the actionable activities of the business; and
each prime measures is exclusive of all other prime measures.

7. A method in accordance with claim 1, further comprising:
selecting a subset of said plurality of prime measures for each respective aggregate measure which best defines that aggregate measure for said business; and
calculating a value of at least one of said prime measures from at least one of said selected subsets to provide an indication of said business performance.

8. A method in accordance with claim 7, wherein:
said selected subset of prime measures for each aggregate measure comprises between five and nine prime measures.

9. A method in accordance with claim 7, wherein:
said selected subset of prime measures for each aggregate measure comprises seven prime measures.

10. A method in accordance with claim 7, further comprising:
adding at least one industry standard prime measure to at least one of said selected subsets of prime measures.

11. A method in accordance with claim 7, further comprising:
customizing at least one of said prime measures in at least one of said selected subsets to better define at least one of said aggregate measure for said business.

12. A method in accordance with claim 1, wherein:
said plurality of business aspects comprises at least a demand management aspect, a supply management aspect, and a support services aspect.

13. A method in accordance with claim 12, wherein:
the plurality of aggregate measures established for the for the demand manage aspect comprises at least a market responsiveness aggregate measure, a sales effectiveness aggregate measure, and a product development effectiveness aggregate measure;
the plurality of aggregate measures established for the supply management aspect comprises at least a customer responsiveness aggregate measure, a supplier effectiveness aggregate measure, and an operational efficiency aggregate measure; and
the plurality of aggregate measures established for the support services aspect comprises at least a human resources responsiveness aggregate measure, an information technology responsiveness aggregate measure, and a finance and regulatory responsiveness aggregate measure.

14. A method in accordance with claim 13, wherein:
said plurality of prime measures established for said market responsiveness aggregate measure comprises at least the following prime measures: target market index, market coverage index, market share index, opportunity/threat index, product portfolio index, channel profitability index, and configurability index;
said plurality of prime measures established for said sales effectiveness aggregate measure comprises at least the following prime measures: sales opportunity index, sales cycle index, sales close index, sales price index, cost of sales index, forecast accuracy, and customer retention index;
said plurality of prime measures established for said product development effectiveness aggregate measure comprises at least the following prime measures: new products index, feature function index, time to market index, and research and development success index;
said plurality of prime measures established for said customer responsiveness aggregate measure comprises at least the following prime measures: on-time delivery, order fill rate, material quality, service accuracy, service performance, customer care performance, agreement effectiveness, and transformation ratio;
said plurality of prime measures established for said supplier effectiveness aggregate measure comprises at least the following prime measures: supplier on-time delivery, supplier order fill rate, supplier material quality, supplier service accuracy, supplier service performance, supplier care performance, supplier agreement effectiveness, and supplier transformation ratio;
said plurality of prime measures established for said operational efficiency aggregate measure comprises at least the following prime measures: cash-to-cash cycle time, conversion cost, asset utilization, and sigma value;
said plurality of prime measures established for said human resources responsiveness aggregate measure comprises at least the following prime measures: recruitment effectiveness index, benefits administration index, skills inventory index, employee training index, human resources advisory index, and human resources total cost index;
said plurality of prime measures established for said information technology responsiveness aggregate measure comprises at least the following prime measures: systems performance, IT support performance, partnership ratio, service level effectiveness, new projects index, and IT total cost index; and
said plurality of prime measures established for said finance and regulatory responsiveness aggregate measure comprises at least the following prime measures:
compliance index, accuracy index, advisory index, and cost of service index.

15. A method in accordance with claim 14, wherein:
a change in the target market index causes a change in at least one of said market share index, said opportunity/threat index, said market coverage index, said sales cycle index, said sales close index, and said new products index;
a change in the market coverage index causes a change in at least one of said market share index, said product portfolio index, said sales opportunity index, said sales cycle index, said sales close index, said sales price index, said cost of sales index, said forecast accuracy index, said on-time delivery, and said service accuracy;
a change in the market share index causes a change in at least one of said opportunity/threat index, said sales cycle index, said sales close index, said forecast accuracy index, and said new products index;
a change in the opportunity/threat index causes a change in at least one of said target market index, said market share index, said product portfolio index, said sales cycle index, said sales close index, said forecast accuracy index, and said new products index;
a change in the product portfolio index causes a change in at least one of said market share index, said opportunity/threat index, said sales cycle index, said sales close index, said forecast accuracy index, and said new products index;
a change in said channel profitability index causes a change in at least one of said market share index, said opportunity/threat index, said configurability index, said market coverage index, said sales cycle index, said sales close index, and said cost of sales index; and
a change in said configurability index causes a change in at least one of said market share index, said opportunity/threat index, said sales cycle index, said sales close index, said cost of sales index, said on-time delivery, said order fill rate, said material quality, said service accuracy, and said sigma value.

16. A method in accordance with claim 14, wherein:
a change in the sales opportunity index causes a change in at least one of said market share index, said product portfolio index, said sales cycle index, said sales close index, said sales price index, and said forecast accuracy index;
a change in the sales cycle index causes a change in at least one of said market share index, said product portfolio index, said sales close index, and said forecast accuracy index;
a change in the sales close index causes a change in at least one of said market share index, said product portfolio index, said sales cycle index, and said forecast accuracy index;
a change in the sales price index causes a change in at least one of said sales cycle index, said sales close index, and said cost of sales index;
a change in the cost of sales index causes a change in at least one of said sales cycle index, said sales close index, and said sales price index;
a change in the forecast accuracy causes a change in at least one of said on-time delivery, said order fill rate, said cash-to-cash cycle time, said conversion cost, and said asset utilization; and
a change in the customer retention index causes a change in at least one of said market share index, said sales cycle index, said sales close index, said sales price index, and said cost of sales index.

17. A method in accordance with claim 14, wherein:
a change in the new products index causes a change in at least one of said target market index, said market share index, said opportunity/threat index, said configurability index, said product portfolio index, said sales cycle index, and said sales close index;
a change in the feature function index causes a change in at least one of said target market index, said market share index, said opportunity/threat index, said configurability index, said product portfolio index, said sales cycle index, said sales close index, said conversion cost index, and said asset utilization;
a change in the time to market index causes a change in at least one of said market share index, said configurability index, said product portfolio index, said sales cycle index, and said sales close index; and
a change in the research and development success index causes a change in at least one of said market share index, said opportunity/threat index, said configurability index, said product portfolio index, said sales cycle index, and said sales close index.

18. A method in accordance with claim 14, wherein:
a change in the on-time delivery causes a change in at least one of said market share index, said configurability index, said sales cycle index, said sales close index, said cash-to-cash cycle time, said conversion cost, and said asset utilization;
a change in the order fill rate causes a change in at least one of said market share index, said configurability index, said sales cycle index, said sales close index, said cash-to-cash cycle time, said conversion cost, and said asset utilization;
a change in the material quality causes a change in at least one of said market share index, said configurability index, said sales cycle index, said sales close index, said cash-to-cash cycle time, said conversion cost, and said asset utilization;
a change in the service accuracy causes a change in at least one of said market share index, said configurability index, said sales cycle index, said sales close index, said cash-to-cash cycle time, said conversion cost, and said asset utilization;
a change in the service performance causes a change in at least one of said agreement effectiveness, and said transformation ratio;
a change in the customer care performance causes a change in at least one of said agreement effectiveness, said transformation ratio, and said service performance;
a change in the agreement effectiveness causes a change in at least one of said market share index, said sales cycle index, said sales close index, said cash-to-cash cycle time, said conversion cost, and said asset utilization; and
a change in the transformation ratio causes a change in at least one of said market share index, said sales cycle index, said sales close index, said cash-to-cash cycle time, said conversion cost, and said asset utilization.

19. A method in accordance with claim 14, wherein:
a change in the supplier on-time delivery causes a change in at least one of said time to market index, said on-time delivery, said order fill rate, said cash-to-cash cycle time, said conversion cost, and said asset utilization;
a change in the supplier order fill rate causes a change in at least one of said market share, said sales cycle, said sales close, said cash-to-cash cycle time, said conversion cost, and said asset utilization;
a change in the supplier material quality causes a change in at least one of said market share index, said sales cycle index, said sales close index, said cash-to-cash cycle time, said conversion cost, and said asset utilization;
a change in the supplier service accuracy causes a change in at least one of said market share index, said sales cycle index, said sales close index, said cash-to-cash cycle time, said conversion cost, and said asset utilization;
a change in the supplier service performance causes a change in at least one of said supplier care performance, said supplier agreement effectiveness, and said supplier transformation ratio;
a change in the supplier care performance causes a change in at least one of said supplier agreement effectiveness, said supplier transformation ratio, and said supplier service performance;
a change in the supplier agreement effectiveness causes a change in at least one of said market share index, said sales cycle index, said sales close index, said cash-to-cash cycle time, said conversion cost, and said asset utilization; and
a change in the supplier transformation ratio causes a change in at least one of said market share index, said sales cycle index, said sales close index, said cash-to-cash cycle time, said conversion cost, and said asset utilization.

20. A method in accordance with claim 14, wherein:
a change in the cash-to-cash cycle time causes a change in at least one of said supplier on-time delivery, said supplier order fill rate, said supplier material quality, said supplier service accuracy, said conversion cost, and said asset utilization;
a change in the conversion cost causes a change in at least one of said supplier on-time delivery, said supplier order fill rate, said supplier material quality, said supplier service accuracy, and said asset utilization;
a change in the asset utilization causes a change in at least one of said on-time delivery, said order fill rate, said material quality, said service accuracy, said cash-to-cash cycle time, and said conversion cost; and
a change in the sigma value causes a change in at least one of said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization.

21. A method in accordance with claim 14, wherein:
a change in the recruitment effectiveness index causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization;
a change in the benefits administration index causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization;
a change in the skills inventory index causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization;
a change in the employee training index causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, said asset utilization, and said recruitment effectiveness;
a change in the human resources advisory index causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization; and
a change in the human resources total cost index causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization.

22. A method in accordance with claim 14, wherein:
a change in the systems performance causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization;
a change in the IT support performance causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization;
a change in the partnership ratio causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization;
a change in the service level effectiveness causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization;
a change in the new projects index causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization; and
a change in the IT total cost index causes a change in at least one of said sales cycle index, said sales close index, said forecast accuracy index, said time to market index, said research and development success index, said on-time delivery, said order fill rate, said material quality, said service accuracy, said supplier on-time delivery, said supplier order fill rate, said supplier material quality, said supplier service accuracy, said cash-to-cash cycle time, said conversion cost, and said asset utilization.

23. A method in accordance with claim 14, wherein:
a change in the compliance index causes a change in at least one of said time to market index, said cash-to-cash cycle time, said conversion cost, and said asset utilization;
a change in the accuracy index causes a change in at least one of said cash-to-cash cycle time, said conversion cost, and said asset utilization;
a change in the advisory index causes a change in at least one of said time to market index, said conversion cost, and said asset utilization; and
a change in the cost of service index causes a change in at least one of said conversion cost and said asset utilization.

24. A method in accordance with claim 14, wherein said target market index is calculated by:
selecting appropriate target market industries based on current product and/or service offerings and planned and budgeted offerings of the business over a future twelve month period using International Standard Industrial Classification codes;
obtaining a relative market size by summing revenue of selected target market industries and dividing the sum by normalized industry revenue; and
multiplying relative market size by relative market growth rate plus one, wherein the relative market growth rate plus one is a weighted average growth rate of all target market industries.

25. A method in accordance with claim 14, wherein said market coverage index is calculated by:
selecting appropriate target market industries based on current product and/or service offerings of the business using International Standard Industrial Classification codes; and
dividing a number of countries in which the business has sold its products or services by a total number of countries where revenue exists for the target market industries selected.

26. A method in accordance with claim 14, wherein said market share index is calculated by:
selecting appropriate target market industries based on current product and/or service offerings of the business using International Standard Industrial Classification codes; and
dividing revenue of the products and/or services offered by the business by total revenue of the selected target market industries.

27. A method in accordance with claim 14, wherein said opportunity/threat index is calculated by:
selecting appropriate target market industries based on current product and/or service offerings and planned and budgeted offerings of the business over a future twelve month period using International Standard Industrial Classification codes; and
computing a market share index for each top five competitor of said business in the selected target market industries by dividing total revenue of each competitor by total revenue of target market industries for each competitor; and
adding the market share indexes for the top five competitors.

28. A method in accordance with claim 14, wherein said product portfolio index is calculated by:
creating a grid starting with a point 0,0 in a lower left corner with gross margin figures labeled on a horizontal axis and growth rate figures labeled on a vertical axis;
determining a current product or service of said business with a highest growth rate in annual revenue;
dividing the growth rate of said product or service with said highest growth rate by two to provide a midpoint of said vertical axis;
determining a current product or service with a highest gross margin in absolute dollar terms;
dividing the dollar gross margin figure of said product or service with said highest gross margin by two to provide a midpoint of said horizontal axis;
extending the respective midpoints of said horizontal and vertical axis to define four quadrants of said grid;
plotting all products and/or services currently offered by the business based on respective growth rates and gross margins in dollar terms on said grid; and
dividing the total revenue of the products and services in all quadrants except the lower left quadrant by the total revenue of the business.

29. A method in accordance with claim 14, wherein said configurability index is calculated by:
determining total revenue generated from options offered on products and services offered by the business during a previous twelve month period; and
dividing the total revenue generated from said options by total revenue of said business;
wherein an option is defined as a feature or function that is purchased as part of a basic product or service and that is not required for the basic product or service to function.

30. A method in accordance with claim 14, wherein said feature function index is calculated by one of:
for businesses selling a product, dividing a number of new component items listed on a bill-of-materials for products released to market during a previous 12 month period by a total number of component items on said bill-of-materials; or
for businesses selling a service, dividing a number of new skill sets required on a bill-of-services for new service offerings released to market during a previous 12 month period by a total number of skill sets required on said bill-of-services.

31. A method in accordance with claim 14, wherein said service performance is calculated by one of:
for a continuous request service, dividing a percentage of hours said service is available to a customer of said business and performing adequately by total hours said service is expected to be available for the customer; or
for a discrete request service, dividing a number of customer requests that are adequately responded to and completed by a total number of requests made by the customer during standard hours of operation.

32. A method in accordance with claim 14, wherein said customer care performance is calculated by:
dividing a number of customer care requests which meet predefined response and resolution criteria by the total number of customer care requests received during standard hours of operation of said business.

33. A method in accordance with claim 14, wherein said agreement effectiveness is calculated by:
dividing a total number of existing customers with a 90% or better service level agreement satisfaction by the total number of existing customers, said satisfaction being based on survey questions relating to said service level agreement.

34. A method in accordance with claim 14, wherein said transformation ratio is calculated by:
dividing (i) a total number of existing customer contracts and engagements and planned contracts and engagements for a future 12 month period, for which goals and benefits are projected in terms of business metrics and for which a roles and responsibilities matrix exists that holds both the business and customer responsible for achieving the projected benefits, by (ii) a total number of existing customer contracts and engagements.

35. A method in accordance with claim 14, wherein said supplier service performance is calculated by one of:
for a continuous request service of said supplier, dividing a percentage of hours said service is available to said business and performing adequately by total hours said service is expected to be available for the business; or
for a discrete request service of said supplier, dividing a number of requests from said business that are adequately responded to and completed by a total number of requests made by the business during standard hours of operation.

36. A method in accordance with claim 14, wherein said supplier care performance is calculated by:
dividing a number of supplier care requests meeting predetermined response and resolution criteria by the total number of supplier care requests made by the business during standard hours of operation.

37. A method in accordance with claim 14, wherein said supplier agreement effectiveness is calculated by:
dividing a total number of existing service providers with a 90% or better service level agreement satisfaction by the total number of existing service providers, said satisfaction being based on survey questions relating to said service level agreement.

38. A method in accordance with claim 14, wherein said supplier transformation ratio is calculated by:
dividing (i) a total number of existing supplier contracts and engagements and planned contracts and engagements for a future 12 month period, for which goals and benefits are projected in terms of business metrics and for which a roles and responsibilities matrix exists that holds both the business and the supplier responsible for achieving the projected benefits, by (ii) a total number of existing supplier contracts and engagements.

39. A method in accordance with claim 14, wherein said recruitment effectiveness index is calculated by:
multiplying average relative recruitment time by relative recruitment cost for each employee hired during a previous 12 month period;
wherein:
said relative recruitment time is calculated by subtracting from 1 a quotient provided by a length of time, measured in days, between recruitment approval and hire date divided by 365; and
said relative recruitment cost is calculated by subtracting from 1 a quotient provided by total recruitment costs divided by committed first year compensation for said hired employees.

40. A method in accordance with claim 14, wherein said skills inventory index is calculated by:
dividing a total number of skills filled by existing employees by a total number of skills required by a business to complete all of said actionable activities.

41. A method in accordance with claim 14, wherein said employee training index is calculated by:
dividing (i) a total number of 8-hour working days each employee has spent in training sponsored by said business during a previous 12 month period by (ii) a product of 225 multiplied by a number of full time equivalent employee positions.

42. A method in accordance with claim 14, wherein said human resources advisory index is calculated by:
dividing (i) a total number of existing human resources projects and projects planned for a future 12 month period, for which goals and benefits are projected in terms of business metrics and for which a roles and responsibilities matrix exists that holds both a human resources department and other business functions responsible for achieving the projected benefits, by (ii) a total number of planned strategic initiatives at a corporate level.

43. A method in accordance with claim 14, wherein said system performance is calculated by:
dividing an amount of hours all systems are available to the business and performing adequately by total hours said systems are expected to be available.

44. A method in accordance with claim 14, wherein said IT support performance is calculated by:
dividing a number of IT support requests meeting predetermined response and resolution criteria by a total number of IT support requests received during standard hours of operation.

45. A method in accordance with claim 14, wherein said partnership ratio is calculated by:
dividing (i) a total number of existing IT projects and projects planned for a future 12 month period, for which goals and benefits are projected in terms of business metrics and for which a roles and responsibilities matrix exists that holds both an IT department and other business functions responsible for achieving the projected benefits, by (ii) a total number of IT projects.

46. A method in accordance with claim 14, wherein said service level effectiveness is calculated by:
dividing a total number of surveyed users with 90% or better service level effectiveness by a total number of surveyed users.

47. A method in accordance with claim 14, wherein said new projects index is calculated by:
dividing (i) a total number of projects that were (a) undertaken within a previous 12 month period and (b) that are currently underway, that operated or are operating on or below budget, at or ahead of schedule, and delivering at least a business value expected from an initial business case, by (ii) a total number of projects, including projects that were undertaken within said previous twelve month period and projects that are currently underway.

48. A method in accordance with claim 14, wherein said compliance index is calculated by:
calendaring by month a total number of legal and regulatory filings and transactions required to conduct normal business operations; and
subtracting from 1 a quotient provided by a number of extensions, late, missed or incorrect filings and transactions for a previous 12 month period divided by said total for said 12 month period.

49. A method in accordance with claim 14, wherein said accuracy index is calculated by:
calendaring by month a total number of documents and reports requested from all internal business operations; and
subtracting from 1 a quotient provided by a number of declined requests, missed deadlines or adjustments necessary following delivery of the document or report divided by said total number requested.

50. A method in accordance with claim 14, wherein said advisory index is calculated by:
dividing (i) a total number of existing finance and/or regulatory projects and projects planned for a future 12 month period, for which goals and benefits are projected in terms of business metrics and for which a roles and responsibilities matrix exists that holds both a finance and regulatory department and other business functions responsible for achieving the projected benefits, by (ii) a total number of planned strategic initiatives at a corporate level.

51. A method in accordance with claim 14, further comprising:
converting a non-index based prime measure into an index-based prime measure by subtracting from 1 a quotient provided by a value of said non-index based prime measure divided by an upper bound of said non-index based prime measure.

52. A method in accordance with claim 51, wherein:
said non-index based prime measure comprises said sales cycle index;
said sales cycle index is expressed by a number of days; and
said upper bound comprises approximately 365 days.

53. A method in accordance with claim 51, wherein:
said non-index based prime measure comprises said time to market index;
said time to market index is expressed by a number of days; and
said upper bound comprises approximately 730 days.

54. A method in accordance with 51, wherein:
said non-index based prime measure comprises said cash-to-cash cycle time;
said cash-to-cash cycle time is expressed by a number of days; and
said upper bound comprises approximately 180 days.

55. A method in accordance with claim 1, further comprising:
applying at least one of said prime measures to at least one of return on investment analysis, linking vision to action, IT to business alignment, external reporting, strategic alliances, due diligence, incentive compensation plans, business activity monitoring, monitoring service level agreements, and supplier ratings.

56. A method in accordance with claim 1, further comprising:
supporting a strategic planning method of said business using at least one of said prime measures.

57. A method in accordance with claim 56, wherein:
said strategic planning method comprises a balanced scorecard method.

58. A method in accordance with claim 1, further comprising:
externally reporting at least one of said calculated prime measures.

59. A computerized system configured to implement the method of claim 1.

60. A system for evaluation of business performance, comprising:
a database for storing: (i) a plurality of business aspects, each of which represents a portion of actionable activities of a business; (ii) a plurality of aggregate measures for each business aspect, each of said aggregate measures comprising a set of related actionable activities for a respective business aspect; and (iii) a plurality of prime measures for each aggregate measure, each of said prime measures quantifying one or more actionable activities from said set of related actionable activities;
a user interface for selecting a subset of said plurality of prime measures for each respective aggregate measure which best defines that aggregate measure for said business; and
a processor for calculating a value of at least one of said prime measures from at least one of said selected subsets to provide an indication of said business performance.
